(19) United States
(12) Patent Application Publication
(10) Pub. No.: US 2024/0420103 A1
(43) Pub. Date: Dec. 19, 2024

(54) SYSTEMS AND METHODS FOR GENERATING A GUI FOR RESCHEDULE OF PAYMENTS

(71) Applicant: Wells Fargo Bank, N.A., San Francisco, CA (US)

(72) Inventors: Nathan B. Coles, San Francisco, CA (US); Tejal Shalinkumar Trivedi, San Francisco, CA (US); Luke Nelson deNatale, San Francisco, CA (US); Matthew Dennison, San Francisco, CA (US); Mattie L. Morris, Chandler, AZ (US); Brenda L. Gordon, San Francisco, CA (US); Margie Tate, San Francisco, CA (US); Trisha Leann Mitchell, San Francisco, CA (US); Qin Dong, San Francisco, CA (US)

(73) Assignee: Wells Fargo Bank, N.A., San Francisco, CA (US)

(21) Appl. No.: 18/210,502

(22) Filed: Jun. 15, 2023

(51) Int. Cl. G06Q 20/10; G06F 3/0486

(52) U.S. Cl. CPC G06Q 20/102; G06F 3/0486

(57) ABSTRACT

Systems and methods method include establishing, a connection between the first computing system and an application of a second computing system, the connection associated with an entity having one or more first accounts with the first computing system and a second account with the application of the second computing system, receiving a dataset corresponding to the second account, the dataset comprising a plurality of data entries corresponding to respective invoices, retrieving account data corresponding to the one or more first accounts with the first computing system, applying, the dataset and the account data as inputs to a machine learning model trained to generate optimized orders, and generating, by the one or more processors, a first user interface including data of a list of the plurality of entries, the plurality of entries being ordered according to the optimized order for the dataset.

### TECHNICAL FIELD

The present disclosure relates to systems and methods for organizing payment schedules. More specifically, the present disclosure relates to systems and method of generating an interactive graphical user interface (GUI) for presenting payment schedules and related financial data and adjusting the payment schedules based on user inputs received within the GUI.

### BACKGROUND

Businesses often use various software platforms to manage their business processes, interactions with customers, and overall day-to-day operations. For example, businesses often use an enterprise resource planning (ERP) platform to manage main business processes (e.g., finance, human resources, etc.), a customer relationship management (CRM) platform to manage the business's interactions with existing and potential customers, and third-party platforms for other day-to-day operations (e.g. financial, banking, etc.). Although businesses move between these software platforms many times a day, these platforms are often fragmented and difficult to move between easily. As such businesses are often forced to increase time, decrease efficiency, and increase overall cost in moving between these platforms in order to manage the business.

### SUMMARY

Systems, methods, and computer-readable media for generating an interactive graphical user interface include establishing, by one or more processors of a first computing system, a connection between the first computing system and an application hosted on one or more servers of a second computing system, the connection associated with an entity having one or more first accounts with the first computing system and a second account with the application of the second computing system, receiving, by the one or more processors, via the connection from the application, a dataset corresponding to the second account, the dataset including a plurality of data entries corresponding to respective invoices, each data entry of the plurality of data entries including an amount, due date, and one or more trade terms associated with payment of the invoice, retrieving, by the one or more processors, from one or more data stores of the first computing system, account data corresponding to the one or more first accounts with the first computing system, applying, by the one or more processors, the dataset and the account data as inputs to a machine learning model trained to generate optimized orders for datasets based on data of data entries of the dataset and corresponding account data, receiving, by the one or more processors, from the machine learning model, an optimized order for the dataset, generating, by the one or more processors, a first user interface including data of a list of the plurality of entries, the plurality of entries being ordered according to the optimized order for the dataset, receiving, by the one or more processors, from a computing device, an update to move an entry of the plurality of entries, and generating, by the one or more processors, a second user interface according to the update from the computing device.

In some embodiments, the method further includes applying, by the one or more processors, at a second time instance, the dataset, the account data, and a locked position of the entry according to the update, to the machine learning model, and receiving, by the one or more processors, a second optimized order for the dataset according to the locked position of the entry. According to various embodiments, the second user interface includes the data of the list of the plurality of entries ordered according to the second optimized order for the dataset. According to various embodiments, the method further includes receiving, by the one or more processors, a user entry corresponding to an expected change to the account data at a future date, wherein the user entry is applied to the machine learning model as another input for generating the optimized order. According to various embodiments, the first user interface includes a calendar view for a time window, wherein each entry of the plurality of entries is represented as a respective element on a date box of the calendar view. According to various embodiments, the calendar view includes a heat map showing a value corresponding to the account data changing over the time window. According to various embodiments, receiving the update includes receiving, by the one or more processors, a drag-and-drop of an element corresponding to the entry from a first date box to a second date box of the calendar view. According to various embodiments, the second user interface includes an update to a heat map of the first user interface based on the element being moved from the first date box to the second date box. According to various embodiments, the update includes a selection of a subset of a plurality of dates in which to move the entry, and wherein the second user interface includes data corresponding to account balances for each scenario corresponding to the subset of the plurality of dates. According to various embodiments, the second user interface comprises an alert displayed over the first user interface, the alert indicating that the update is estimated to cause a negative balance.

Another embodiment is related to a first computing system. The first computing system includes one or more processors configured to establish a connection between the first computing system and an application hosted on one or more servers of a second computing system, the connection associated with an entity having one or more first accounts with the first computing system and a second account with the application of the second computing system, receive, via the connection from the application, a dataset corresponding to the second account, the dataset comprising a plurality of data entries corresponding to respective invoices, each data entry of the plurality of data entries comprising an amount, due date, and one or more trade terms associated with payment of the invoice, retrieve, from one or more data stores of the first computing system, account data corresponding to the one or more first accounts with the first computing system, apply the dataset and the account data as inputs to a machine learning model trained to generate optimized orders for datasets based on data of data entries of the dataset and corresponding account data, receive, from the machine learning model, an optimized order for the dataset, generate a first user interface including data of a list of the plurality of entries, the plurality of entries being ordered according to the optimized order for the dataset, receive, from a computing device, an update to move an entry of the plurality of entries, and generate a second user interface according to the update from the computing device.

According to various embodiments, the one or more processors are configured to apply, at a second time instance, the dataset, the account data, and a locked position of the entry according to the update, to the machine learning model, and receive a second optimized order for the dataset according to the locked position of the entry. According to various embodiments, the second user interface includes the data of the list of the plurality of entries ordered according to the second optimized order for the dataset. According to various embodiments, the one or more processors are configured to receive a user entry corresponding to an expected change to the account data at a future date, wherein the user entry is applied to the machine learning model as another input for generating the optimized order. According to various embodiments, the first user interface includes a calendar view for a time window, wherein each entry of the plurality of entries is represented as a respective element on a date box of the calendar view. According to various embodiments, the calendar view includes a heat map showing a value corresponding to the account data changing over the time window. According to various embodiments, receiving the update includes receiving, by the one or more processors, a drag-and-drop of an element corresponding to the entry from a first date box to a second date box of the calendar view. According to various embodiments, the second user interface includes an update to a heat map of the first user interface based on the element being moved from the first date box to the second date box. According to various embodiments, the update includes a selection of a subset of a plurality of dates in which to move the entry, and wherein the second user interface includes data corresponding to account balances for each scenario corresponding to the subset of the plurality of dates.

Another example embodiment relates to a non-transitory computer readable medium storing instructions that, when executed by one or more processors of a first computing system, cause the one or more processors to establish a connection between the first computing system and an application hosted on one or more servers of a second computing system, the connection associated with an entity having one or more first accounts with the first computing system and a second account with the application of the second computing system, receive, via the connection from the application, a dataset corresponding to the second account, the dataset including a plurality of data entries corresponding to respective invoices, each data entry of the plurality of data entries including an amount, due date, and one or more trade terms associated with payment of the invoice, retrieve, from one or more data stores of the first computing system, account data corresponding to the one or more first accounts with the first computing system, apply the dataset and the account data as inputs to a machine learning model trained to generate optimized orders for datasets based on data of data entries of the dataset and corresponding account data, receive, from the machine learning model, an optimized order for the dataset, generate a first user interface including data of a list of the plurality of entries, the plurality of entries being ordered according to the optimized order for the dataset, receive, from a computing device, an update to move an entry of the plurality of entries, generate a second user interface according to the update from the computing device.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 is a schematic diagram of a computing system, according to an exemplary embodiment.

FIG. 2 is a schematic diagram of an application programming interface (API) gateway circuit of the computing system of FIG. 1, according to an exemplary embodiment.

FIG. 3 is a diagram of a user device of FIG. 1 accessing an enterprise resource that displays institution computing system data, according to an exemplary embodiment.

FIG. 4 is a schematic diagram of the processing circuit in the ICS controller of the computing system of FIG. 1 including a smart financial engine, according to an exemplary embodiment.

FIG. 5 is a block diagram of an example system using supervised learning, according to an exemplary embodiment.

FIG. 6 is a block diagram of a simplified neural network model, according to an exemplary embodiment.

FIG. 7 is a flowchart of a process for providing real-time (or near real time) predictions to a user using the smart financial engine of FIG. 6, according to an exemplary embodiment.

FIG. 8 is a block diagram of an example system using reinforcement learning, according to an exemplary embodiment.

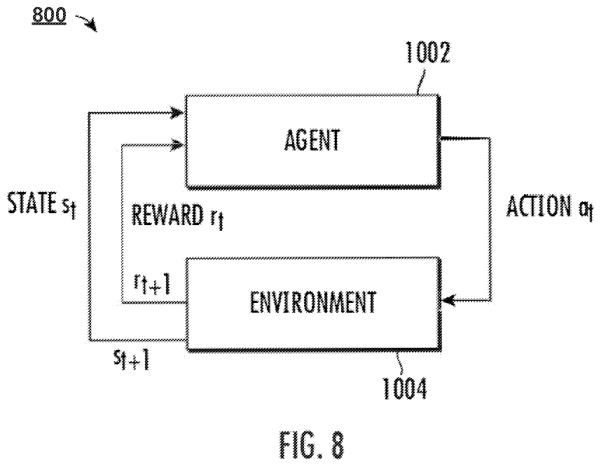

FIG. 9 is a system schematic diagram of another computing system, according to an exemplary embodiment.

FIG. 10 is a graphical user interface generated by the process of FIG. 9, according to an example embodiment.

FIG. 11 is another graphical user interface generated by the process of FIG. 9, according to an example embodiment.

FIG. 12 is another graphical user interface generated by the process of FIG. 9, according to an example embodiment.

FIG. 13 is a flowchart showing a method for optimizing orders for datasets and generating a corresponding graphical user interface, according to an example embodiment.

### DETAILED DESCRIPTION

Following below are more detailed descriptions of various concepts related to, and implementations of, systems and methods for delivering content (such as content relating to products or services offered via an institution) using an institution computing system (ICS) to an enterprise resource, such as an enterprise resource planning (ERP) application or customer relationship management (CRM) application. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

In various implementations, an enterprise may maintain various applications and resources which are used in day-to-day operations. For example, an enterprise may maintain, use, or otherwise access various enterprise resources. Such resources may be or include customer relationship management (CRM) applications (e.g., for establishing leads on new customers, assisting in converting a lead to a sale, planning delivery, and so forth), enterprise resource planning (ERP) applications, such as human resources (HR) or payroll applications, marketing applications, customer service applications, operations/project/supply chain management applications, commerce design applications, and the like. Each of these applications may be maintained as part of suite or platform of applications which are accessible by various users associated with the enterprise. The enterprise resources may be locally-hosted applications or resources (e.g., executing on various computing devices of the enterprise), or cloud-hosted or web-based applications or resources provisioned to the enterprise computing devices and systems by one or more third parties. For example, the enterprise resources may be or include a software suite or platform including a plurality of enterprise resources which are accessible by enterprise computing devices or systems.

Such enterprise resources may be limited in their capabilities to interface with, exchange data with, or otherwise interoperate with other applications or resources of an enterprise. For example, an ERP application (or CRM application) may not be configured to exchange, transmit, receive, or otherwise access data associated with financial accounts associated with the enterprise. As such, enterprise members (or enterprise users) may be required to access multiple applications (e.g., several ERP applications, CRM applications, financial institution applications, etc.) in performing day-to-day operations for the enterprise. Such implementations result in bogged-down user experiences, decreased efficiency, and so forth.

According to an exemplary embodiment, an institution computing system (ICS) is provided that facilitates connections and communications between enterprise resources (e.g., remotely hosted and/or locally executing applications) and an institution through a network of application programming interfaces (APIs). The ICS may include any number of APIs which are configured to facilitate communications and exchange of content and data with enterprise resources. The ICS is configured to provide content and data from the institution corresponding to the enterprise to various enterprise resources, such that a user device accessing an ERP application/CRM application (e.g., installed and/or executing locally on the user device, or hosted on one or more servers and accessed via the user device) may also receive and display real-time data and content from the ICS. With this in mind, an enterprise resource may send various API calls to the ICS, requesting the ICS to communicate content and data (e.g., content and data relating to the institution's products and/or services) in real-time. In various embodiments, the ICS provides various APIs that facilitate real-time interaction between the ICS and enterprise resources.

According to the examples and embodiments described herein, the ICS is configured to standardize and integrate communications between the institution (i.e., the institution's products or services) and the external systems (i.e., the various platforms or resources an enterprise may use or access, such as the ERP applications, CRM applications, or other locally-executing/remotely-executing enterprise resources described herein). The systems and methods described herein may be used by an enterprise to perform various functions related to the institution within an enterprise resource. For instance, the systems and methods described herein may verify and track account balances, view account analytics, and other institution-related transactions and functions, all within various enterprise resources.

Additionally, the systems and methods described herein may leverage data from the enterprise resources. For example, upon an enterprise establishing or otherwise enrolling with one or more enterprise resources (e.g., a CRM application), a user or administrator may provide various information corresponding to the enterprise as part of the enrollment with the enterprise resource (e.g., enterprise name, management information, principle place of business, tax information, etc.). Such information may be maintained by the enterprise resource (e.g., at one or more servers or memory corresponding to the enterprise resource, which may be maintained by a service-provider of the enterprise resource). According to the systems and methods described herein, a user of the enterprise resource may establish or open an account for an enterprise, apply for a loan instrument, or perform other functions seamlessly within an enterprise resource. Upon selecting an option within the enterprise resource, the enterprise resource may transmit such information relating to the enterprise along with a request to open an account, apply for a loan instrument, etc. Such implementations and embodiments provide for a simple and seamless user experience by leveraging data from an enterprise resource.

In some embodiments, the systems and methods described herein may provide recommendations to a user/financial institution/third party relating to a financial state of the user (or entity associated with the user). For example, the systems and methods descried herein may leverage enterprise resource data of an entity for determining a predicted financial state of the entity. The enterprise resource data may include ERP data, CRM data, financial institution data, publicly available data, etc., which is associated with the entity. The systems and methods described herein may receive such data via various APIs, accessing various databases, and so forth. The systems and methods described herein may determine the predicted financial state of the entity using trained machine learning models. Such machine learning models may be trained using historic data of customers/entities, and may generate or determine predicted financial states of customers based on given inputs (i.e., given enterprise resource data). The machine learning models may be configured to generate recommendations. For example, the machine learning models may be configured to generate recommendation which optimize a financial state of the customer (i.e., to apply for a loan using collateral determined from an ERP application, to invest in particular short term opportunities when assets and predicted accounts receivable are greater than accounts payable, and so forth). In some embodiments, the recommendations may be used by the customer, by an account manager (i.e., an employee or analyst with the institution who is assigned to provide recommendations to the customer), or a third party. For example, the third party may be a loan underwriter who may use the recommendation and/or predicted financial state to make an underwriting decision (i.e., the recommendation and/or predicted financial state may be an input to another model for making an underwriting decision). Various other examples and embodiments are described in greater detail below.

For purposes of reading the description of the various embodiments below, the following enumeration of sections of the specification of their respective contents are provided: Section I: Integrating Enterprise Resource and Institution Computing System; Section II: Machine Learning Model(s); Section III: Systems and Methods for Generating a GUI for Reschedule of Payments.

### Section I: Integrating Enterprise Resource and Institution Computing System

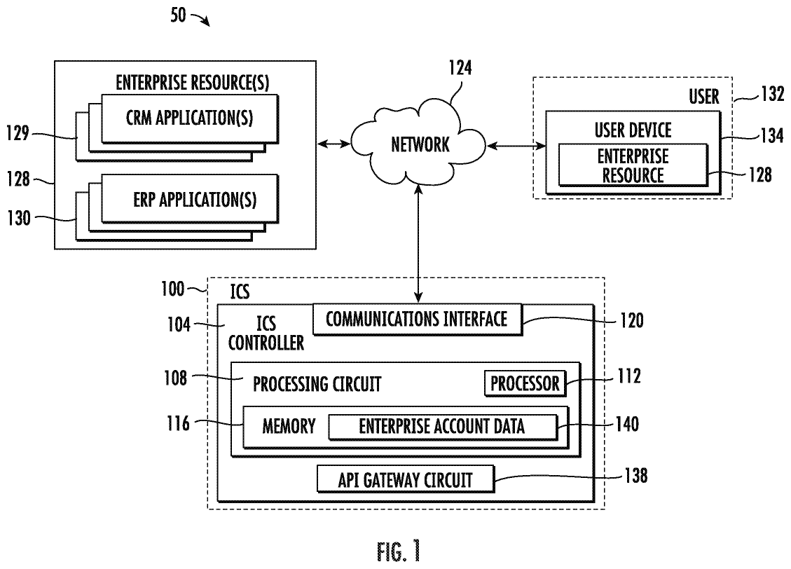

Referring now to FIG. 1, a schematic diagram of a computing system 50 is shown, according to an exemplary embodiment. Computing system 50 is shown to include an institution computing system (ICS) 100, which includes an ICS controller 104. The ICS controller 104 includes a processing circuit 108, having a processor 112 and a memory 116. The ICS controller 104 may also include, and the processing circuit 108 may be communicably coupled to, a communications interface 120 such that the processing circuit 108 may send and receive content and data via the communications interface 120. As such, the ICS controller 104 may be structured to communicate via one or more networks 124 with other devices and/or applications. The computing system 50 is shown to include enterprise resources 128 including a plurality of CRM applications 129 and a plurality of ERP applications 130, and a user device 134 accessing an enterprise resource 128 (which may be one of the enterprise resources 128). In some embodiments, the ICS controller 104, the enterprise resources 128, and the user device 134 may be communicably coupled and configured to exchange data over the network 124, which may include one or more of the Internet, cellular network, Wi-Fi, Wi-Max, a proprietary banking network, a proprietary retail or service provider network, or other type of wired or wireless network. The ICS controller 104 may be configured to transmit, receive, exchange, or otherwise provide data to one or more of the enterprise resources 128. The ICS controller 104 is shown to include an application programming interface (API) gateway circuit 138. The API gateway circuit 138 may be configured to facilitate the transmission, receipt, and/or exchange of data between the ICS controller 104 and the enterprise resources 128.

Referring to FIG. 1 generally, the ICS controller 104 is associated with (e.g., owned, managed, and/or operated by) the institution computing system (ICS) 100. In the example depicted, the ICS 100 is a computing system configured to maintain data or content relating to one or more one or more enterprises (e.g., enterprise account data 140). According to the embodiments described herein, the ICS 100 may be configured to transmit existing enterprise account data 140 to one or more enterprise resources 128. For example, the ICS 100 may be configured to provide various content and data relating to different institution accounts, such as general ledger accounts, lending, money transfers, issuing credit or debit, etc. Thus, the ICS controller 104 is structured or configured to maintain and provide, or otherwise facilitate providing, the content and data (e.g., the enterprise account data 140) to devices and/or applications associated with internal or external users (e.g., users having an account with the institution corresponding to the ICS 100, users seeking to establish an account with the institution, etc.). In some embodiments, the ICS controller 104 is structured or configured control access to the enterprise account data 140 (e.g., by authenticating an enterprise resource 128 or a user of the enterprise resource 128).

In some embodiments, the ICS controller 104 may be implemented within a single computer (e.g., one server, one housing, etc.). In other embodiments, the ICS controller 104 may be distributed across multiple servers or computers, such as a group of two or more computing devices/servers, a distributed computing network, a cloud computing network, and/or any other type of computing system capable of accessing and communicating via local and/or global networks (e.g., the network 124). Further, while FIG. 1 shows applications outside of the ICS controller 104 (e.g., the network 124, the enterprise resources 128, etc.), in some embodiments, one or more of the enterprise resources 128 may be hosted within the ICS controller 104 (e.g., within the memory 116).

As shown in FIG. 1, the ICS controller 104 is shown to include the processing circuit 108, including the processor 112 and the memory 116. The processing circuit 108 may be structured or configured to execute or implement the instructions, commands, and/or control processes described herein with respect to the processor 112 and/or the memory 116. FIG. 1 shows a configuration that represents an arrangement where the processor 112 is embodied in a machine or computer readable media, as described below. However, FIG. 1 is not meant to be limiting as the present disclosure contemplates other embodiments, such as where the processor 112, or at least one circuit of processing circuit 108 (or ICS controller 104), is configured as a hardware unit. All such combinations and variations are intended to fall within the scope of the present disclosure.

The processing circuit 108 is shown to include the processor 112. The processor 112 may be implemented or performed with a general purpose single- or multi-chip processor, a digital signal processor (DSP), an application specific integrated circuit (ASIC), one or more field programmable gate array (FPGAs), or other suitable electronic processing components. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the circuits of the processor 112 may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit 108 is also shown to include the memory 116. The memory 116 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 116 may be or include tangible, non-transient volatile memory or non-volatile memory. The memory 116 may also include database components, object code components, script components, or any other type of information structure for supporting the activities and information structures described in the present application. According to an exemplary embodiment, the memory 116 is communicably connected to the processor 112 via the processing circuit 108 and includes computer code for executing (e.g., by the processing circuit 108 and/or the processor 112) one or more processes described herein.

As shown in FIG. 1, the ICS controller 104 is also shown to include an application programming interface (API) gateway circuit 138. In some embodiments, the external devices (e.g., CRM application(s) 129 or ERP application(s) 130 of the enterprise resources 128, user device 134 having enterprise resource 128, etc.) may include API protocols that are used to establish an API session between the ICS controller 104 and the external devices. In this regard, the API protocols and/or sessions may allow the ICS 100 to communicate content and data (e.g., associated with the institution's products and/or services) to be displayed directly within the external devices (e.g., CRM application(s) 129, ERP application(s) 130, user device 134, etc.). For example, the external device may activate an API protocol (e.g., via an API call), which may be communicated to the ICS controller 104 via the network 124 and the communications interface 120. The API gateway circuit 138 may receive the API call from the ICS controller 104, and the API gateway circuit 138 may process and respond to the API call by providing API response data. The API response data may be communicated to the external device via the ICS controller 104, communications interface 120 and the network 124. The external device may then access (e.g., display) the API response data (e.g., associated with the ICS 100 product and/or service) on the external device.

As such, the API gateway circuit 138 is structured to initiate, receive, process, and/or respond to API calls (e.g., via the ICS controller 104 and the communications interface 120) over the network 124. That is, the API gateway circuit 138 may be configured to facilitate the communication and exchange of content and data between the external devices (e.g., CRM applications 129, ERP applications 130, user device 134, etc.) and the ICS controller 104. Accordingly, to process various API calls, the API gateway circuit 138 may receive, process, and respond to API calls using other circuits, as discussed below. Additionally, the API gateway circuit 138 may be structured to receive communications (e.g., API calls, API response data, etc.) from other circuits. That is, other circuits may communicate content and data to the ICS controller 104 via the API gateway circuit 138. Therefore, the API gateway circuit 138 is communicatively coupled other circuits of the ICS controller 104, either tangibly via hardware, or indirectly via software.

Still referring to FIG. 1, the computing system 50 may further include a plurality of enterprise resources 128. The enterprise resources 128 may be or include various systems or applications which are provided to an enterprise (e.g., by one or more service providers of the enterprise resource(s) 128). The enterprise resources 128 may be configured to facilitate management of resources corresponding to various entities in various industries. The enterprise resources 128 is shown to include a plurality of customer relationship management (CRM) applications 129. The CRM applications 129 may be or include applications for establishing leads on new customers, assisting in converting a lead to a sale, planning delivery, and so forth. The enterprise resources 128 is shown to include a plurality of ERP applications 130. The ERP applications 130 may include human resources (HR) or payroll applications, marketing applications, customer service applications, operations/project/supply chain management applications, commerce design applications, and the like.

The enterprise resources 128 may be implemented on or otherwise hosted on a computing system, such as a discrete server, a group of two or more computing devices/servers, a distributed computing network, a cloud computing network, and/or another type of computing system capable of accessing and communicating using local and/or global networks (e.g., the network 124). Such computing system hosting the enterprise resources 128 may be maintained by a service provider corresponding to the enterprise resource(s) 128. The enterprise resources 128 may be accessible by various computing devices or user devices associated with an enterprise responsive to enrollment of the enterprise with the enterprise resources 128. The CRM applications 129 and/or the ERP applications 130 may include software and/or hardware capable of implementing a network-based or web-based applications (e.g., closed-source and/or open-source software like HTML, XML, WML, SGML, PHP, CGI, Dexterity, TypeScript, Node, etc.). Such software and/or hardware may be updated, revised, or otherwise maintained by resource or service providers of the enterprise resources 128. The CRM and ERP application(s) 129, 130 may be accessible by a representative(s) of a small or large business entity, any customer of the institution, and/or any registered (or unregistered) user of the products and/or service provided by one or more components of the computing system 50. As such, the enterprise resources 128 (including the CRM application(s) 129 and/or the ERP application(s) 130) may be or include a platform (or software suite) provided by one or more service providers which is accessible by an enterprise having an existing account with the ICS 100. In some instances, the enterprise resources 128 may be accessible by an enterprise which does not have an existing account with the ICS 100, but may open or otherwise establish an account with the ICS 100 using a CRM application 129 and/or an ERP application 130 of the enterprise resources 128, as described in greater detail below.

The enterprise resources 128 may be configured to establish connections with other systems in the computing system 50 (e.g., the ICS 100, the user device 134, etc.) via the network 124. Accordingly, the CRM application(s) 129 and/or ERP application(s) 130 of the enterprise resources 128 may be configured to transmit and/or receive content and data to and/or from the ICS controller 104 (e.g., via the communications interface 120) over the network 124. For example, and as described in greater detail below, an ERP application 130 (or CRM application 129) may activate an API protocol (e.g., via an API call) associated with the ICS 100 (e.g., to open an account, to request or apply for a loan instrument, to verify or determine an account balance, etc.). The API call may be communicated to the ICS controller 104 via the network 124 and the communications interface 120. The ICS controller 104 (e.g., the API gateway circuit 138) may receive, process, and respond to the API call by providing API response data. The API response data may be communicated to the ERP application 130 (or CRM application 129) via the communications interface 120 and the network 124, and the ERP application 130 (or CRM application 129) may access (e.g., analyze, display, review, etc.) the content and data received from the ICS 100.

In an exemplary embodiment, the enterprise resources 128 may be configured to include an interface that displays the content and data communicated from the ICS controller 104. For example, the enterprise resources 128 may include a graphical user interface, a mobile user interface, or any other suitable interface that may display the content and data (e.g., associated with products and services of the ICS 100) to the enterprise resources 128. In this regard, enterprise resources 128, and entities associated with the enterprise resources 128 (e.g., customers, employees, shareholders, policy holders, etc.), may access, view, analyze, etc. the content and data transmitted by the ICS controller 104 remotely using the enterprise resources 128.

Still referring to FIG. 1, the computing system 50 may further include a user device 134 associated e.g., owned by, used by, etc. with a user 132. The user device 134 may be or include a mobile phone, a tablet, a laptop, a desktop computer, an IoT-enabled device (e.g., an IoT-enabled smart car), a wearable device, a virtual/augmented reality (VR/AR) device, and/or other suitable user computing devices capable of accessing and communicating using local and/or global networks (e.g., the network 124). Wearable computing devices may refer to types of devices that an individual wears, including, but not limited to, a watch (e.g., a smart watch), glasses (e.g., eye glasses, sunglasses, smart glasses, etc.), bracelet (e.g., a smart bracelet), etc. In an exemplary embodiment, the user 132 may be a customer or client of the ICS 100 associated with the ICS controller 104 (e.g., a user having access to one or more accounts of another entity, such as a business or enterprise, another individual, etc.).

The user device 134 may be configured to establish connections with other systems in the computing system 50 (e.g., ICS 100, enterprise resources 128, etc.) via the network 124. Accordingly, the user device 134 may be able to transmit and/or receive content and data to and/or from the ICS controller 104 (e.g., via the communications interface 120) over the network 124. In some embodiments, the user device 134 may be able to transmit and/or receive content and data to and/or from the enterprise resources 128 over the network 124. In an exemplary embodiment, the user device 134 may include software and/or hardware capable of accessing a network-based or web-based application. For example, in some instances, the user device 134 may include an application that includes (closed-source and/or open-source) software such as HTML, XML, WML, SGML, PHP (Hypertext Preprocessor), CGI, Dexterity, TypeScript, Node, etc.

As shown in FIG. 1, the user device 134 is also shown to access an enterprise resource 128, which may be or include one or more of the enterprise resources 128 described above (e.g., a CRM application 129, an ERP application 130). For example, a user of the enterprise resource 128 may provide log-in credentials associated with an enterprise, to access the corresponding enterprise resource 128. In some embodiments, the enterprise resource 128 may be a standalone application. In some embodiments, the enterprise resource 128 may be incorporated into one or more existing applications of the user device 134. The enterprise resource 128 may be downloaded by the user device 134 prior to its usage, hard coded in the user device 134, and/or be a network-based or web-based interface application. In this regard, the ICS controller 104 may provide content and data (e.g., relating to the ICS 100 products or services) to the enterprise resource 128 via the network 124, for displaying at the user device 134. The enterprise resource 128 may receive the content and data (e.g., directly from the ICS controller 104, or indirectly from the ICS controller 104), and the user device 134 may process and display the content and data remotely to the user through the enterprise resource 128 displayed at the user device 134.

In some embodiments, the user device 134 may prompt the user 132 to log onto or access a web-based interface before using the enterprise resource 128. Further, prior to use of the enterprise resource 128, and/or at various points throughout the use of the enterprise resource 128, the user device 134 may prompt the user 132 to provide various authentication information or log-in credentials (e.g., password, a personal identification number (PIN), a fingerprint scan, a retinal scan, a voice sample, a face scan, any other type of biometric security scan) to ensure that the user 132 associated with the user device 134 is authorized to use the enterprise resource 128 and/or access the data from the ICS corresponding to the enterprise.

In an exemplary embodiment, the enterprise resource 128 is structured to provide displays on the user device 134, which provide content and data corresponding to the enterprise resource 128 to the user 132. As described in greater detail below, the enterprise resource 128 may be configured to display, render, or otherwise provide data from the ICS 100 (such as enterprise account data 140) to the user 132 via the user device 134. As such, the user device 134 may permit the user 132 to access the content and data of the ICS 100 that is maintained and distributed by the ICS controller 104 using the enterprise resource 128 (e.g., via the communications interface 120 and the network 124).

In an exemplary embodiment, an enterprise resource 128 accessed via the user device 134 may be configured to transmit, send, receive, communicate, or otherwise exchange data with the ICS 100. For example, an ERP application 130 (e.g., or CRM application 129) may have an option for viewing account information relating to accounts with the ICS 100. The user 132 of the user device 134 (e.g., a registered user having an account with the institution corresponding to the ICS 100) may select the option on the ERP application 130 to view the account information of the user 132 within the ERP application 130. The ERP application 130 may activate an API protocol (e.g., via an API call) to request the information from the ICS controller 104 corresponding to the account information. The ERP application 130 may communicate the API call to the ICS controller 104 via the network 124 and the communications interface 120. The ICS controller 104 (e.g., the API gateway circuit 138) may receive, process, and respond to the API call to provide API response data. For example, responsive to the ERP application 130 (or ICS controller 104) authenticating the user 132 as described above, the ERP application 130 may transmit data corresponding to the user (e.g., a user identifier) with the API call to the ICS controller 104. The ICS controller 104 may perform a look-up function in an accounts database using the user identifier from the API call to generate the API response data including the enterprise account data 140. The API response data may be communicated to the ERP application 130 via the communications interface and the network 124. In some embodiments, the ERP application 130 may display the response data to the user 132 (e.g., via the ERP application(s) 130), such as the enterprise account data 140.

Similarly, the user device 134 may communicate with the ICS 100, via the network 124, requesting enterprise resource 128 data (e.g., data from a CRM application 129, data from an ERP application 130, etc.) to view on a page associated with the ICS 100. For example, the user device 134 may display a page or user interface corresponding to the ICS 100 which includes an option for viewing analytics on conversion of leads to sales from the CRM application 129. The user device 134 may receive a selection of the option, and initiate a request for the ICS 100 to request the customer information from the CRM application 129. The ICS 100 (e.g., the ICS controller 104 via the communications interface 120) may process the request from the user device 134 (e.g., as discussed above), and activate an API protocol (e.g., via an API call) associated with the request (i.e., and the CRM application 129, etc.). The API call may be communicated to the CRM application 129 via the network. The CRM application 129 may receive, process, and respond to the API call by providing API response data as described above. The API response data may be communicated to the ICS 100 (e.g., the ICS controller 104 via the network and the communications interface 120). In some embodiments, a webpage or website (or application) associated with the ICS 100 may display the CRM data received from the CRM application 129 along with ICS data (e.g., account data, balances, etc.).

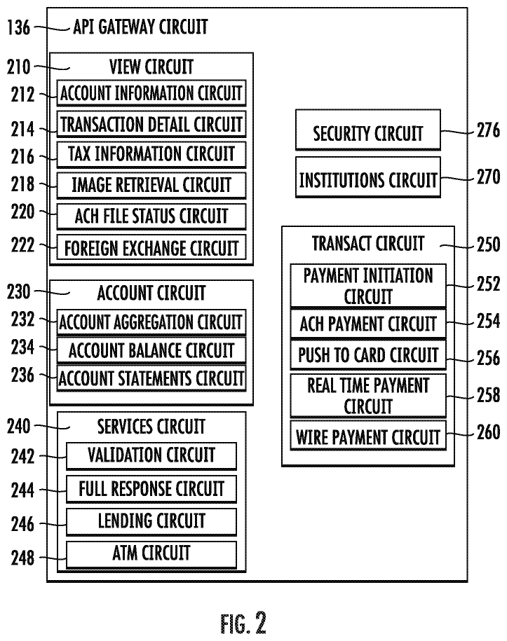

Referring to FIG. 2, a schematic diagram of the API gateway circuit 138 of FIG. 1 is shown, according to an exemplary embodiment. As shown in FIG. 2, the API gateway circuit 138 may include a plurality of circuits. As some examples, the API gateway circuit 138 may include a view circuit 210, an account circuit 230, a services circuit 240, a transact circuit 250, an institutions circuit 270, and a security circuit 276. Each of the plurality of circuits (e.g., circuits 210-276) may also include a plurality of sub-circuits, as discussed below.

Referring generally to FIG. 2, in an exemplary embodiment the plurality of circuits (e.g., circuits 210-276) of the API gateway circuit 138 are structured to initiate, receive, process, and/or respond to API calls. As discussed briefly with regard to FIG. 1, the enterprise resources 128 may be configured to have API protocols which are used to establish sessions and facilitate communications (or exchange of data) between the ICS controller 104 and the enterprise resources 128. As such, the circuits (e.g., circuits 210-276) may receive an API call from the enterprise resources 128 (e.g., the ERP applications 130, CRM applications 129, etc.) via the network 124, the communications interface 120, and the API gateway circuit 138. The circuits (e.g., circuits 210-276) may then process the API call, and transmit content and data in response (e.g., API response data). The API response data may include information corresponding to the API call and associated with the corresponding circuit of the ICS 100. The data (e.g., API response data) may be transmitted back to the enterprise resources 128 through the communications interface 120, and the network 124. In this regard, the API protocols and sessions may allow the enterprise resources 128 and the user device 134 to request, transmit, receive, and/or display information relating to the content corresponding to the ICS 100 (e.g., via the ICS controller 104). Various examples of general functions which may be performed by each of the circuits 210-276 provided in the API gateway circuit 138 are described in greater detail below.

As shown in FIG. 2, the view circuit 210 may include a plurality of circuits that are generally structured to retrieve and provide information. The view circuit 210 may include an account information circuit 212, a transaction detail circuit 214, a tax information circuit 216, an image retrieval circuit 218, an automated clearing house (ACH) file status circuit 220, and a foreign exchange circuit 222. In an exemplary embodiment, the account information circuit 212 may be structured to retrieve and provide account balance and transaction data for checking and/or saving accounts. The transaction detail circuit 214 may be structured to retrieve and provide same day or previous day data (e.g., details, summaries, etc.) for one or more accounts. The transaction detail circuit 214 may also be structured to retrieve and provide specific transaction data (e.g., wire payments, ACH payments, checks, deposits, etc.). The tax information circuit 216 may be structured to retrieve and provide historic tax information (e.g., documents) of entities having an account with the ICS 100. In some embodiments, the tax information circuit 216 may be structured to retrieve and provide tax data from the ICS 100 with certain criteria (e.g., trust accounts, brokerage accounts, mortgages, student loans, etc.).

Referring still to the view circuit 210, in an exemplary embodiment, the image retrieval circuit 218 may be structured to retrieve and provide images of certain checks and/or deposit slips (e.g., paid, deposited, returned, etc.). In some embodiments, the image retrieval circuit 218 may be structured to provide data (e.g., research, reconciliation, collection, adjustments, etc.) relating to accounts maintained at the ICS 100. In other embodiments, the image retrieval circuit 218 may be structured to retrieve and provide data relating to checks (e.g., paid checks, deposited checks, returned checks, etc.) over a predetermined period for accounts maintained at the ICS 100. The ACH file status circuit 220 may be structured to retrieve and/or provide the status of ACH files and ACH batches originated through the ICS 100. The foreign exchange circuit 222 may be structured to retrieve and provide national and international exchange data (e.g., exchange rates) and certain ICS 100 account information (e.g., customer, supplier, payroll, marketplace, etc.).

As shown in FIG. 2, the account circuit 230 may also include a plurality of other circuits, which may be generally structured to retrieve and provide account specific information. For example, the account circuit 230 may include an account aggregation circuit 232, an account balance circuit 234, and an account statements circuit 236. In an exemplary embodiment, the account aggregation circuit 232 may be structured to retrieve and provide data relating to an ICS 100 account (e.g., checking, savings, credit, loan, investment, etc.). The account aggregation circuit 232 may also be structured to retrieve and provide historic and/or real-time account data (e.g., balances, transactions, holdings, etc.) of accounts maintained at the ICS 100.

Still referring to the account circuit 230, in an exemplary embodiment, the account balance circuit 234 may be structured to retrieve and provide balance information for national and/or international commercial accounts (e.g., checking, savings, general ledger, etc.). The account balance circuit 234 may also be structured to retrieve and provide additional balance information (e.g., opening balance, current available balance, closing ledger, etc.). The account statements circuit 236 may be structured to retrieve and provide certain ICS 100 account statements (e.g., accounts with certain credit cards, trust accounts, lines of credit, etc.) based on an input.

As shown in FIG. 2, the services circuit 240 may also include a plurality of other circuits that are generally configured to process and provide information. The services circuit 240 may include a validation circuit 242, a full response circuit 244, a lending circuit 246, and an automated teller machine (ATM) circuit 248. In an exemplary embodiment, the validation circuit 242 may be structured to process and provide status and ownership information for certain accounts maintained at the ICS 100. In some embodiments, the validation circuit 242 is structured to process certain new and/or existing ICS 100 accounts (e.g., enroll or establish new accounts, collect premiums on accounts, issue or collect taxes on accounts, etc.). The full response circuit 244 may be structured to provide detailed response information on ICS 100 accounts by processing the status and ownership information of certain ICS 100 accounts. In some embodiments, the full response circuit 244 may be structured to process the status and ownership information from the validation circuit 242.

Referring still to the services circuit 240, in an exemplary embodiment the lending circuit 246 may be structured to process a new or existing ICS 100 account (e.g., enroll new lending account, provide increased lending, etc.). Also, in an exemplary embodiment, the ATM circuit 248 may be structured to provide ICS 100 account information (e.g., checking, credit card, etc.) and/or process the ICS 100 account (e.g., process payment of an account balance).

As shown in FIG. 2, the transact circuit 250 may also include a plurality of circuits that are generally structured to initiate, process, and/or provide information relating to certain payments. The transact circuit 250 includes a payment initiation circuit 252, an automated clearing house (ACH) payment circuit 254, a push to card circuit 256, a real time payment circuit 258, and a wire payment circuit 260. In an exemplary embodiment, the payment initiation circuit 252 may be structured to initiate payment to certain ICS 100 national and international accounts. Similarly, the payment initiation circuit 252 may be structure to process and respond to API calls relating to the status of payments to certain ICS 100 national and international accounts. The ACH payment circuit 254 may be structured to initiate payment to other ICS 100 accounts (e.g., customer accounts, supplier accounts, payroll accounts, marketplace accounts, etc.). In some embodiments, the ACH payment circuit 254 may be structured to process the payment of claims to certain ICS 100 accounts (e.g., policyholders, insurance accounts, etc.).

Still referring to the transact circuit 250, in an exemplary embodiment, the push to card circuit 256 may be structured to initiate and/or process payment to certain ICS 100 accounts (e.g., consumer debit accounts, life insurance accounts, etc.). The real time payment circuit 258 may also be structured to initiate and/or process payment to certain ICS 100 accounts (e.g., policyholders, medical accounts, etc.) in real-time. Also in an exemplary embodiment, the wire payment circuit 260 may be structured to initiate and/or process wire payment to certain ICS 100 accounts. In some embodiments, the wire payment circuit 260 may also be structured to process and provide the status of the wire payment, or process and provide receipt of the wire payment.

As shown in FIG. 2, the API gateway circuit 138 includes an institutions circuit 270. The institutions circuit 270 may be structured to retrieve and provide information relating to ICS 100 institutions. For example, in an exemplary embodiment the institutions circuit 270 may be structured to provide information relating to a specific ICS 100 institution (e.g., geographic location, services offered, scheduling information, etc.). In some embodiments, the institutions circuit 270 may be structured to process an input (e.g., a current location, service preferences, dialect preference, etc.). In response, the institutions circuit 270 may be configured to provide information on fixed locations of facilities relating to the institution based on the input (e.g., closest facility to the user, services offered at the facility, directions to the facility, available appointments at the facility, etc.).

As shown in FIG. 2, the API gateway circuit 138 may also include a security circuit 276. The security circuit 276 may be structured to authenticate and/or validate a user accessing the ICS controller 104 (e.g., from the external devices or applications) to ensure sharing and permission preferences. The security circuit 276 may authenticate and/or validate a user via a variety of modalities input into the external devices or applications, for example a password, a fingerprint scan, a retinal scan, a voice sample, a face scan, and/or any other type of biometric security scan. The security circuit 276 may also be structured to process (e.g., verify) a supplemental authentication when applicable (e.g., a two-factor authentication (2FA) is presented on the enterprise resource(s) 128 and/or user device 134). The supplemental authentication may occur as part of a process to authorize an enterprise resource 128 (e.g., ERP application(s) 128, CRM application(s) 129, etc.) to access data or content (e.g., ICS data) from the ICS 100 (e.g., the ICS controller 104).

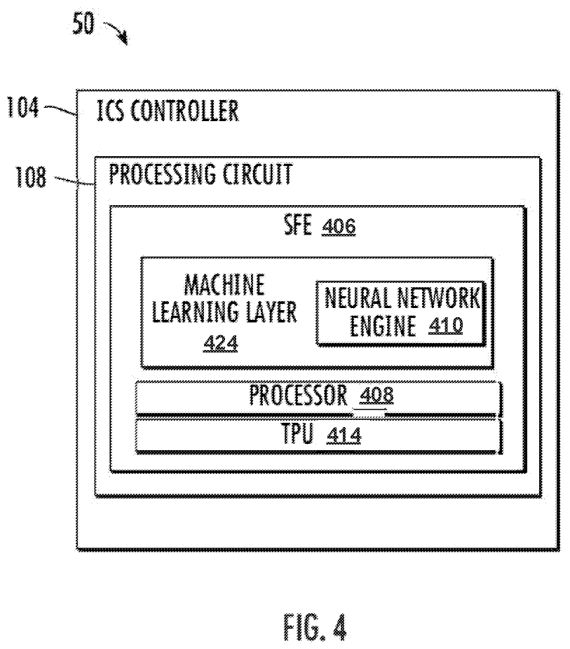

Referring to FIG. 1 and FIG. 4, in some embodiments, the ICS controller 104 may include a smart financial engine 406. Specifically, FIG. 4 shows a schematic diagram of the processing circuit 108 in the ICS controller 104, as part of computing system 50 may include a smart financial engine (SFE) 406 as shown, according to an exemplary embodiment. SFE is shown to include a machine learning layer 424, a processor 608, and a tensor processing unit (TPU) 414.

SFE 406 may be configured to receive enterprise resources 128 data, including data from CRM applications 129 and data from ERP applications 130. Data received by the SFE 406 may include, for example, accounts receivable data, accounts payable data, account balance data (derived from one or more enterprises), liquid asset data, illiquid asset data, 401K data, investment retirement account (IRA) data, property holding data, investment opportunities, collateral backing opportunities, refinance opportunities, user 132 feedback (e.g., whether a customer, customer relationship manager, or the like ranked (or scored) the recommendation as “positive” or “negative”, whether the customer, customer relationship manager, or the like ranked (or scored) the recommendation as aggressive, conservative or moderate), and the like.

The SFE 406 may access enterprise resources 128 using the API gateway circuit 138 described above with reference to FIG. 1. The SFE 406 may also access one or more databases using API gateway circuit 138. In some embodiments, the data received from databases may include trained machine learning models, thresholds, and the like. Alternatively or additionally, an enterprise may store trained machine learning models and/or threshold. Alternatively or additionally, the SFE 406 may store the trained machine learning models and/or thresholds. As such, the SFE 406 may include, maintain, or otherwise access the trained machine learning models described herein.

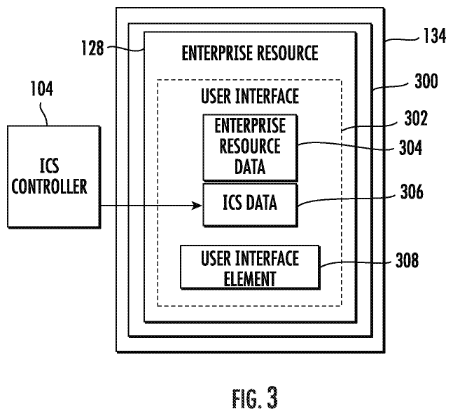

In some embodiments, a user 132 may configure the SFE 406 by interacting with a user interface (e.g., user interface 302 in FIG. 3). For example, a user 132 may configure various thresholds or select machine learning models to be implemented via SFE 406. In some embodiments, the SFE 406 receives the user's 132 instructions and/or configurations using an API (e.g., via the API gateway circuit 138).

A processor 608 may be the logic in a device (e.g., SFE 406) that receives software instructions. A central processing unit (CPU) may be considered any logic circuit that responds to and processes instructions. CPUs are configured to execute various types of instructions. One or more algorithmic logic units (ALU) may be incorporated in processors to perform necessary calculations in the event an instruction requires a calculation be performed. When a CPU performs a calculation, it performs the calculation, stores the calculation in memory, and reads the next instruction to determine what to do with the calculation.

A different type of processor 608 utilized in SFE 406 may be the graphics processing unit (GPU). The SFE 406 may include both GPU and CPU processors 608. A GPU is a specialized electronic circuit designed to quickly perform calculations and access memory. As GPUs are specifically designed to perform calculations quickly, GPUs may have many ALUs allowing for parallel calculations. Parallel calculations mean that calculations are performed more quickly (e.g., in parallel to other tasks being performed by the processor 608). GPUs, while specialized, are still flexible in that they are able to support various applications and software instructions. As GPUs are still relatively flexible in the applications they service, GPUs are similar to CPUs in that GPUs perform calculations and subsequently store the calculations in memory as the next instruction is read.

In some embodiments, processor 608 may include a neural network engine 410. In other embodiments, the SFE 406 may access the neural network engine 410 using an API. That is, each machine learning model may have an associated API that may be used to call the machine learning model. Instructions for invoking various machine learning models in the machine learning layer 424 may be stored in memory 116. The various machine learning models may include neural networks (including convolutional neural networks, deep neural networks), Support Vector Machines (SVMs), Random Forests, and the like.

Employing APIs to invoke machine learning models allows the machine learning models to be implemented in different environments. For example, the machine learning models may be implemented in cloud or on-premise environments. In addition, machine learning models may be added over time (e.g., by a user 132 using a user interface 302).

Processor 608 may call machine learning models using the instructions stored in memory 116, access databases using the instructions stored in memory 116, and may receive information from a user interface 302 using the instructions stored in memory 116. The use of APIs facilitates the scalability of SFE 406.

A neural network engine 410 is an engine that utilizes the inherent parallelisms in a neural network to improve and speed up the time required for calculations. For example, generally, processors performing neural network instructions perform the neural network calculations sequentially because of the dependencies in a neural network. For example, the inputs to one neuron in a network may be the outputs from the previous neuron. In other words, a neuron in a first layer may receive inputs, perform calculations, and pass the output to the next neuron. However, many of the same computations are performed numerous times during the execution of the neural network. For example, multiplication, addition and executing activation functions are performed at every neuron. Further, while neurons within the same layer may be dependent on one another, neurons are independent from neurons in other layers. Thus, a neural network engine 410 may be used to capitalize on the parallelisms of a neural network. For example, every addition, multiplication and execution of the activation function may be performed simultaneously for different neurons in different layers.

In addition to CPUs and GPUs, SFE 406 may additionally have a tensor processing unit (TPU) 414. TPU 414, while still a processor like a CPU and GPU, is an Artificial Intelligence application-specific integrated circuit. TPUs may not require any memory, as their purpose is to perform computations quickly. Thus, TPU 414 performs calculations and subsequently passes the calculations to an ALU or outputs the calculations such that more calculations may be performed. Thus, TPUs may be faster than their counterparts CPUs and GPUs.

### Section II: Machine Learning Model(s)

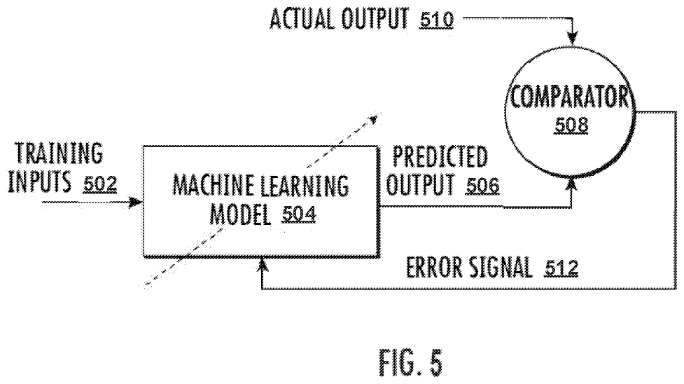

Referring to FIG. 5, a block diagram of an example system using supervised learning, is shown. Supervised learning is a method of training a machine learning model given input-output pairs. An input-output pair is an input with an associated known output (e.g., an expected output).

Machine learning model 504 may be trained on known input-output pairs such that the machine learning model 504 can learn how to predict known outputs given known inputs. Once the machine learning model 504 has learned how to predict known input-output pairs, the machine learning model 504 can operate on unknown inputs to predict an output.

The machine learning model 504 may be trained based on general data and/or granular data (e.g., data based on a specific user 132) such that the machine learning model 504 may be trained specific to a particular user 132.

Training inputs 502 and actual outputs 510 may be provided to the machine learning model 504. Training inputs 502 may include accounts receivable data, accounts payable data, account balance data, liquid asset data, illiquid asset data, 401k data, IRA data, and the like. Actual outputs 510 may include recommendations (e.g., investment opportunities, collateral backing opportunities, refinance opportunities, and the like), user feedback (e.g., whether a customer, customer relationship manager, or other specialist ranked (or scored) the recommendation as positive or negative, whether the customer, customer relationship manager, or the like ranked (or scored) the recommendation as aggressive, conservative or moderate), actual future accounts receivable data, actual future accounts payable data, actual future account balance data, actual future liquid asset data, actual future illiquid asset data, actual future 401k data, actual future IRA data, and the like.

The inputs 502 and actual outputs 510 may be received from historic enterprise resource 128 data from any of the data repositories. For example, a data repository of an enterprise resource 128 may contain an account balance of a user 132 a year ago. The data repository may also contain data associated with the same account six months ago and/or data associated with the same account currently. Thus, the machine learning model 504 may be trained to predict future account balance information (e.g., account balance information one year into the future or account balance information six months into the feature) based on the training inputs 502 and actual outputs 510 used to train the machine learning model 504.

The SFE 406 may include one or more machine learning models 504. In an embodiment, a first machine learning model 504 may be trained to predict data associated with a financial state of a user 132 based on current user 132 enterprise resource 128 data. For example, the first machine learning model 504 may use the training inputs 502 (e.g., accounts receivable data, accounts payable data, account balance data, liquid asset data, illiquid asset data, 401k data, IRA data, and the like) to predict outputs 506 (e.g., future accounts receivable data, future accounts payable data, future account balance data, future liquid asset data, future illiquid asset data, future 401k data, future IRA data, and the like), by applying the current state of the first machine learning model 504 to the training inputs 502. The comparator 508 may compare the predicted outputs 506 to actual outputs 510 (e.g., actual future accounts receivable data, actual future accounts payable data, actual future account balance data, actual future liquid asset data, actual future illiquid asset data, actual future 401k data, actual future IRA data, and the like) to determine an amount of error or differences. For example, the future predicted accounts receivable data (e.g., predicted output 506) may be compared to the actual accounts receivable data (e.g., actual output 510).

In other embodiments, a second machine learning model 504 may be trained to make one or more recommendations to the user 132 based on the predicted data of the financial state of the user 132. For example, the second machine learning model 504 may use the training inputs 502 (e.g., future accounts receivable data, future accounts payable data, future account balance data, future liquid asset data, future illiquid asset data, future 401k data, future IRA data, and the like) to predict outputs 506 (e.g., a probability of a predicted investment opportunity, a probability of a predicted collateral backing opportunity, a probability of a predicted refinance opportunity, and the like) by applying the current state of the second machine learning model 504 to the training inputs 502. The comparator 508 may compare the predicted outputs 506 to actual outputs 510 (e.g., a selected investment opportunity, a selected collateral backing, predicted refinance opportunity, and the like) to determine an amount of error or differences.

The actual outputs 510 may be determined based on historic data of recommendations made to the user 132 by a customer relationship manager or other specialist. In an illustrative non-limiting example, a user 132 six months ago may have been in a particular financial state. In response to being in the particular financial state, the user 132 may have been advised of to seek an additional loan with various identified collateral backing. Thus, the input-output pair would be the particular financial state of the user 132 and the loan with identified collateral backing. In another illustrative non-limiting example, a user 132 four months ago may have been in a particular financial state. In response to being the in particular financial state, the user 132 may have been advised to invest in one or more enterprises. The user 132 may have received 30 day notes and rates, 60 day notes and rates, and 90 day notes and rates and selected an investment opportunity. Thus, the input-output pair would be the particular financial state of the user 132 and the selected investment opportunity. Accordingly, the second machine learning model 504 may learn to predict a recommendation (e.g., investment opportunity, collateral backing, refinance opportunity) for a given financial state. As described in greater detail below, the recommendation may be provided to the user, to a team member associated with the enterprise (i.e., to provide the recommendation to the user), and/or to other entities associated with the enterprise and/or user (such as loan underwriters in some instances).

In some embodiments, a single machine leaning model 504 may be trained to make one or more recommendations to the user 132 based on current user 132 data received from enterprise resources 128. That is, a single machine leaning model may be trained using the training inputs 502 (e.g., accounts receivable data, accounts payable data, account balance data, liquid asset data, illiquid asset data, 401k data, IRA data, and the like) to predict outputs 506 (e.g., a probability of a predicted investment opportunity, a probability of a predicted collateral backing opportunity, a probability of a predicted refinance opportunity, and the like) by applying the current state of the machine learning model 504 to the training inputs 502. The comparator 508 may compare the predicted outputs 506 to actual outputs 510 (e.g., a selected investment opportunity, a selected collateral backing, a selected refinance opportunity, and the like) to determine an amount of error or differences. The actual outputs 510 may be determined based on historic data associated with the recommendation to the user 132 (e.g., determined by a customer relationship manager or other specialist).

Training the machine learning model 504 with the data from the enterprise resources 128 allows the machine learning model 504 to learn, and benefit from, the interplay between the current and future states of the user/entity and enterprise resource 128 data. For example, training the machine learning model to predict a future account balance with accounts receivable input data may result in improved accuracy of the future account balance. Conventional approaches may predict a future account balance information algorithmically, without consideration of other factors that may affect the future account balance such as accounts receivable data. Generally, machine learning models are configured to learn the dependencies between various inputs. Accordingly, the machine learning model 504 learns the dependencies between the enterprise resource data and other data/factors of the user, resulting in improved predictions over predictions that are determined individually and/or independently.

During training, the error (represented by error signal 512) determined by the comparator 508 may be used to adjust the weights in the machine learning model 504 such that the machine learning model 504 changes (or learns) over time. The machine learning model 504 may be trained using a backpropagation algorithm, for instance. The backpropagation algorithm operates by propagating the error signal 512. The error signal 512 may be calculated each iteration (e.g., each pair of training inputs 502 and associated actual outputs 510), batch and/or epoch, and propagated through the algorithmic weights in the machine learning model 504 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 504 may be tuned to reduce the amount of error, thereby minimizing the differences between (or otherwise converging) the predicted output 506 and the actual output 510. The machine learning model 504 may be trained until the error determined at the comparator 508 is within a certain threshold (or a threshold number of batches, epochs, or iterations have been reached). The trained machine learning model 504 and associated weighting coefficients may subsequently be stored in memory 116 or other data repository (e.g., a database) such that the machine learning model 504 may be employed on unknown data (e.g., not training inputs 502). Once trained and validated, the machine learning model 504 may be employed during a testing (or an inference phase). During testing, the machine learning model 504 may ingest unknown data to predict future data (e.g., accounts receivable, accounts payable, 401k data, IRA data, account balance, and the like).

Using the systems and methods described herein, the SFE 406 can have a formalized approach to estimate future enterprise resource 128 data in a single automated framework based on current enterprise resource 128 data. The SFE 406 uses the data available from the enterprise resources 128 to predict future data and a user 132 financial state.

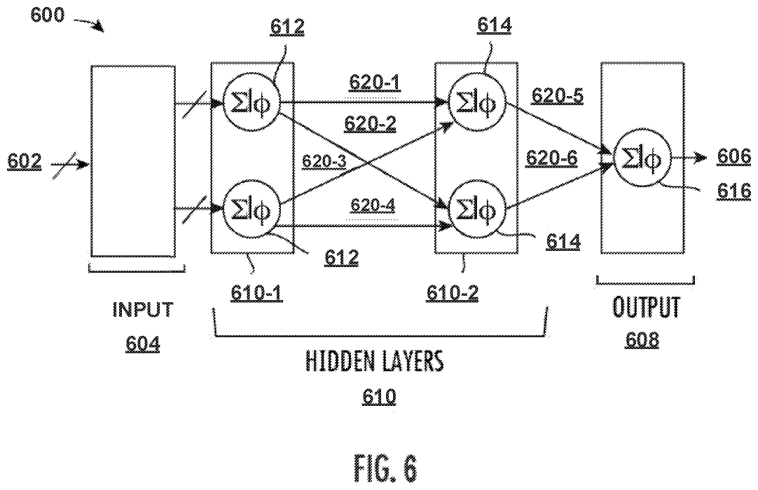

Referring to FIG. 6, a block diagram of a simplified neural network model 600 is shown. The neural network model 600 may include a stack of distinct layers (vertically oriented) that transform a variable number of inputs 602 being ingested by an input layer 604, into an output 606 at the output layer 608.

The neural network model 600 may include a number of hidden layers 610 between the input layer 604 and output layer 608. Each hidden layer has a respective number of nodes (612, 614 and 616). In the neural network model 600, the first hidden layer 610-1 has nodes 612, and the second hidden layer 610-2 has nodes 614. The nodes 612 and 614 perform a particular computation and are interconnected to the nodes of adjacent layers (e.g., nodes 612 in the first hidden layer 610-1 are connected to nodes 614 in a second hidden layer 610-2, and nodes 614 in the second hidden layer 610-2 are connected to nodes 616 in the output layer 608). Each of the nodes (612, 614 and 616) sum up the values from adjacent nodes and apply an activation function, allowing the neural network model 600 to detect nonlinear patterns in the inputs 602. Each of the nodes (612, 614 and 616) are interconnected by weights 620-1, 620-2, 620-3, 620-4, 620-5, 620-6 (collectively referred to as weights 620). Weights 620 are tuned during training to adjust the strength of the node. The adjustment of the strength of the node facilitates the neural network's ability to predict an accurate output 606.

In some embodiments, the output 606 may be one or more numbers. For example, output 606 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

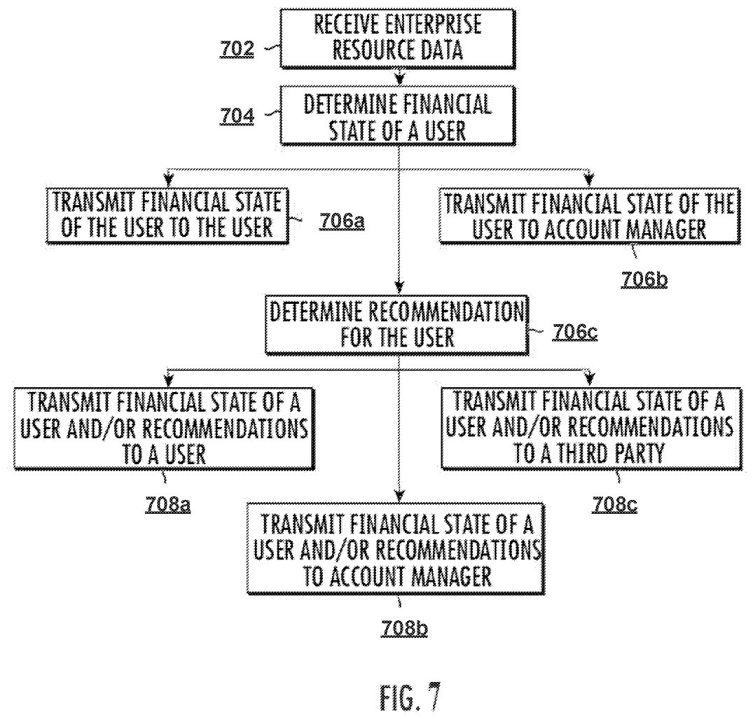

Referring now to FIG. 7, a flow chart of a process 900 for providing real-time (or near real-time) SFE 406 predictions to a user is shown, according to an exemplary embodiment. The process 900 may include steps 702-708. However, other embodiments may include additional or alternative steps, or may omit one or more steps altogether. The method 900 is described as being executed using the computing system 50 of FIG. 1, and in particular the SFE of FIG. 4 such that reference is made to the components described above to aid in the description of process 900. However, one or more steps of process 900 may be executed by any number of computing systems. For example, one or more computing systems may locally perform part or all of the steps described in FIG. 7.

At step 702, the ICS 100 receives enterprise resource 128 data. The enterprise resource 128 data may include, for example, data which is maintained by the ICS 100 for an enterprise (i.e., enterprise account data 140 for instance), data which is maintained by an enterprise on enterprise computing devices and/or data which is maintained by a third party on behalf of an enterprise. The enterprise resource 128 data may include, for example, data which is provided to a customer relationship management (CRM) application 129, data which is provided to an enterprise resource planning (ERP) application 130, data which is provided during account setup at a financial institution, data which is maintained by third parties (i.e., publicly known information), etc. In some embodiments, the ICS controller 104 may receive enterprise resource 128 data via the communications interface 120 by CRM Application(s) 129, ERP Application(s) 130, and the like. Alternatively or additionally, the ICS controller 104 may receive enterprise resource 128 data via the communications interface 120 by a user device 134. For example, a user 132 may manually enter enterprise resource 128 data (e.g., 401k information) into a user device 134 which transmits the enterprise resource 128 data to the ICS controller 104 via the communications interface 120. The data received by the ICS controller 104 may be ingested by the SFE 406 and in particular, by a trained machine learning model 504.

In some embodiments, the ICS controller 104 may receive enterprise resource 128 data based on one or more user 132 inputs via a user device 134. For example, a user 132 may manually trigger SFE 406 using drop-downs buttons, highlighted rows, voice commands, etc.

In other embodiments, the ICS controller 104 may receive enterprise resource 128 data based on predetermined configurations. The predetermined configurations may include temporal triggers. For example, the ICS controller 104 may periodically (e.g., annually, every six months, quarterly, monthly, bi-weekly, weekly, daily, etc.) query one or more CRM Application(s) 129, ERP Application(s) 130, and the like (i.e., via API calls to corresponding APIs for the CRM application(s) and or ERP applications 129, 130) for enterprise resource 128 data.

In yet other embodiments, the ICS controller 104 may receive enterprise resource 128 data based on triggering conditions. A triggering condition may include monitoring enterprise resource 128 data obtained from CRM application(s) 129 and/or ERP application(s) 130, and determining that one or more thresholds have been satisfied. For example, the ICS controller 104 may monitor accounts payable data obtained from CRM application(s) 129 and/or ERP application(s) 130. Every time a predetermined number of accounts (such as one new account, two new accounts, etc.) are added as an account payable, the ICS controller 104 may be triggered to query CRM Application(s) 129, ERP Application(s) 130, and the like for enterprise resource 128 data.

Alternatively or additionally, the ICS controller 104 may be triggered to query CRM Application(s) 129, ERP Application(s) 130, and the like for enterprise resource 128 data in response to determining that a withdrawal (or deposit) satisfies a threshold. For example, transactions exceeding a threshold (determined by, for example, comparing an account balance at a first point in time and an account balance at a second point in time) may be a triggering condition.

It should also be appreciated that step 702 may be presupposed by an authentication of a user/user device-session in order to gain access the CRM application(s) 129, ERP application(s) 130 and/or the ICS 100. The authentication may be completed via the security circuit 276 of the ICS 100 prior to accessing or requesting any data via the ICS 100 via an API call (e.g., prior to the step 702). Any authentication may also be completed via a password, biometric scan, voice command, etc., as described above with regard to FIG. 2.

At step 704, the ICS controller 104 may determine a user's 132 financial state. The user's financial state may be a state of the user's 132 financial accounts. For example, the financial state of the user 132 may be a current or future state of the user's 132 accounts receivable data, accounts payable data, account balance data, liquid asset data, illiquid asset data, 401k data, IRA data, property holdings, and the like.

The user's 132 financial state may be determined by employing one or more trained machine learning models 504. For example, the trained machine learning model 504 may receive enterprise resource 128 data (e.g., accounts receivable data, accounts payable data, account balance data (derived from one or more enterprises), liquid asset data, illiquid asset data, 401K data, IRA data, property holding data, and the like) and determine a future financial state of the user's accounts receivable data, accounts payable data, account balance data, liquid asset data, illiquid asset data, 401k data, IRA data, and the like. The extent of the prediction of the financial state may depend on how the machine learning model 504 was trained (e.g., trained to predict a financial state six months into the future, trained to predict one year into the future, etc.).

In some embodiments, the dimensionality of the received enterprise resource 128 data may be reduced such that only statistically significant data (or other data determined to be relevant) is applied to the machine leaning model 504. For example, the SFE may reduce the dimensionality of the data received by the SFE 406 using clustering, support vector machines, decision trees, filtering, and the like. For example, statistically insignificant data (e.g., noise) may be removed using a Kalman filter, a Z-test, a T-test, or other machine learning model.

The ICS controller 104 may proceed to step 706a, 706b, 706c or some combination.

At step 706a, the ICS controller 104 may transmit the user's 132 financial state to the user 132. In some embodiments, the ICS controller 104 may transmit the information via a notification. The notification may include the predicted future financial state of the user's 132 accounts receivable data, accounts payable data, account balance data, liquid asset data, illiquid asset data, 401k data, IRA data, and the like. The notification may also categorize the predicted future financial state of the user 132.

In some embodiments, the SFE 406 may categorize the predicted financial state of the user 132 into negative and positive predicted financial states. For example, a negative financial state may be a in which the user 132 does not have enough money to pay various accounts payable at the end of a month. A positive financial state may be a state in which the user 132 has a surplus of money. In a different example, a positive financial state may be a state in which the user 132 has enough money available in one or more accounts to make the necessary monthly payments.

The SFE 406 may determine whether the financial state of the user is a negative financial state based on statistically or algorithmically combining (or comparing) one or more predicted outputs from the machine learning model 504. For example, the SFE 406 may compare the predicted accounts receivable data with the predicted account balance and predicted accounts payable data. If the predicted accounts payable value is greater than an aggregated predicated account balance and predicted accounts receivable value, then the SFE 406 may determine that the user is in a negative financial state.

In contrast, if the aggregated predicted account balance and predicted accounts receivable value is greater than the predicted accounts payable value (by a predetermined percentage amount, for example), then the SFE 406 may determine that the user 132 is not in a negative financial state. For instance, if the aggregated (e.g., sum) predicted account balance and predicted accounts receivable value is 10% greater than the predicted accounts payable value, then the SFE 406 may determine that the user 132 is not in a negative financial state. In some embodiments, if the SFE 406 determines that the user 132 is not in a negative financial state, then the SFE 406 may determine that the user 132 is in a positive financial state.

In other embodiments, the SFE 406 may employ one or more thresholds (statically or dynamically determined) to evaluate whether the user 132 is in a positive financial state. For example, if the aggregated predicted account balance and predicted accounts receivable value is 10% greater than the predicted accounts payable value, then the SFE 406 may determine that the user is not in a negative financial state, and if aggregated predicted account balance and predicted accounts receivable value is 30% greater than the predicted accounts payable value, then the SFE 406 may determine that the user is in a positive financial state.

At step 706b, the ICS controller 104 may transmit the user's 132 financial state to an account manager (i.e., rather than the user). For example, the ICS controller 104 may transmit the user's financial state to a customer relationship manager which is assigned (i.e., in the CRM application 129) to the user or entity. The customer relationship manager may be an account manager at the institution corresponding to the ICS controller 104. The customer relationship manager may use the financial state for updating a financial plan for the user, for determining one or more recommendations for the customer, etc. In some embodiments, the ICS controller 104 may transmit the information via a notification. The notification may include the future financial state of the user's 132 accounts receivable data, accounts payable data, account balance data, liquid asset data, illiquid asset data, 401k data, IRA data, and the like. The notification may also categorize the future financial state of the user 132 into positive and/or negative financial states, as discussed herein.

At step 706c, the ICS controller 104 may determine a recommendation for the user 132. That is, the financial state information may be fed into one or more downstream applications. More specifically, the SFE 406 may determine a recommendation for the user 132 using a machine learning model 504 trained to receive financial state information such as enterprise resource 128 data including accounts receivable data, accounts payable data, account balance data, liquid asset data, illiquid asset data, 401k data, IRA data, property holdings, and the like and predict recommendations (e.g., opening an account, transferring holdings between accounts to optimize savings, investing money in stocks, investing money in bonds, investing money with various companies, taking out a loan, identifying property as collateral, identifying future accounts receivable as collateral, refinancing a loan, and the like).

Alternatively or additionally, the machine learning model 504 may be trained to receive predicted financial state information such as future accounts receivable data, future accounts payable data, future account balance data, future liquid asset data, future illiquid asset data, future 401k data, future IRA data, future property holdings, and the like and predict recommendations (e.g., investing money in stocks, investing money in bonds, investing money with various companies, identifying property as collateral, identifying future accounts receivable as collateral, refinancing a loan, and the like).

The output of the machine learning model 504 may include probabilities of various recommendations. The SFE 406 may determine a recommendation based on the recommendation with the maximum probability. The recommendation may indicate a recommendation with the highest probability that a customer relationship manager would recommend, and/or a recommendation that results in the highest probability of a favorable outcome. For example, a favorable outcome may be an outcome that includes the user's 132 account balance and accounts receivable value being greater than the user's 132 accounts payable value. Recommendations may be based on historic recommendations and include recommending the user 132 to invest their money in stocks, invest their money in bonds, invest their money with various companies, identify property as collateral, identify future accounts receivable as collateral, refinance the loan, and the like.

Alternatively or additionally, in response to a user 132 input, SFE 406 may determine a particularly classified recommendation. Recommendations may be classified into various groups, where groups of recommendations may include aggressive recommendations, conservative recommendations, or moderate recommendations. The recommendations may be classified and/or grouped based on information received from customer and/or customer relationship managers feedback. The SFE 406 may employ clustering (such as k-means clustering or other suitable unsupervised learning methods) to determine the recommendations in the groups of recommendations.

In k-means clustering, for example, groups of recommendations may be clustered by randomly generating a centroid and associating a group of recommendations (e.g., aggressive recommendations, conservative recommendations, or moderate recommendations) with the centroid. Recommendations may be clustered based on relative distances between the recommendations and the centroids. The centroids may be moved to new relative locations based on minimizing the average distance of each of the recommendations associated with the centroid. Each time the centroid moves, the distance between the recommendations and the centroid may be recalculated. The clustering process may iterate until a stopping criteria is met (e.g., recommendations do not change clusters, the sum of the distances is minimized, a maximum number of iterations is reached). In some embodiments, distances may be measured between the recommendations and centroids using Euclidean distance. In other embodiments, the distance between the recommendations and the centroids may be measured based on correlation features of the recommendations.

Alternatively or additionally, each recommendation may be treated as a centroid. The recommendations may be clustered based on the distances of the centroid recommendations to the other recommendations. Distance measure may include, for example, the smallest maximum distance to other recommendations, the smallest average distance to other recommendations, and the smallest sum of squares of distances to other recommendations.

In an example, a user 132 may use the user device 134 to select (e.g., via drop-down menus, scroll wheels, etc.) an aggressive recommendation. Accordingly, the SFE 406 may determine a recommendation from the group of aggressive recommendations with the maximum probability responsive to the user 132 selecting their preferred level of aggressiveness for a recommendation

Referring back to FIG. 7, in some embodiments, other probabilistic analyses may be performed to determine one or more recommendations based on present or future financial state information. For example, a Monte Carlo simulation may be used to generate a probability distribution for each recommendation. Various recommendations may be mathematically represented using functions. For example, a recommendation function may include various quadratic terms representing considerations determined by a customer relationship manager or other specialist when providing recommendations to users 132 based on the user's 132 financial state.

One or more variables in a function may be assigned as a random variable such that each time an iteration is performed, a value will be selected for the random variable from a normal distribution, uniform distribution, lognormal distribution, and the like depending on the variable. For example, some variables may have values selected from a normal distribution of values, while other variables have values selected from a normal distribution of values.

The SFE 406 may determine a recommendation based on a maximum probability of each of the maximum probabilities of the Monte Carlo recommendation simulations. Alternatively or additionally, the SFE 406 may determine a maximum recommendation based on a group of recommendations, where the group of recommendations may include groups of aggressive recommendations, conservative recommendations, or moderate recommendations.

Referring back to FIG. 7, the ICS controller 104 may proceed to step 708a, 708b, 708c or some combination.

At step 708a, the ICS controller 104 may transmit the user's 132 financial state and the recommendations to the user 132. In some embodiments, the ICS controller 104 may transmit the information via a notification. The notification may include the future financial state of the user 132 (e.g., 132 accounts receivable data, accounts payable data, account balance data, liquid asset data, illiquid asset data, 401k data, IRA data, and the like) and the recommendation based on predicted data of a financial state of the user 132.

For example, the SFE 406 may determine in the future that the user 132 will not have enough liquid assets to pay their bills. Based on the future prediction of the financial state of the user 132 (e.g., not having enough liquid assets to pay their bills), the SFE 406 may recommend taking out a loan and using particular property as collateral backing. Accordingly, the user 132 may avoid the predicted future financial state (e.g., not having enough liquid assets to pay their bills) by presently taking out a loan and using the particular property as collateral backing.

At step 708b, the ICS controller 104 may transmit the user's 132 financial state and/or the recommendations to an account manager. Step 708b may be similar in some regards to step 706b. For example, the ICS controller 104 may transmit the recommendation to an account manager which is assigned to the user. The account manager may be a dedicated team member assigned to the accounts of the user. The account manager may be a general analyst who is receives the recommendation. In these and other embodiments, the account manager may provide the recommendation to the customer. The account manager may provide the recommendation generated by the ICS controller 104 accompanied with other recommendations (i.e., generated by the account manager and/or third parties). In some embodiments, the ICS controller 104 may transmit the information via a notification. The notification may include the future financial state of the user 132 (e.g., 132 accounts receivable data, accounts payable data, account balance data, liquid asset data, illiquid asset data, 401k data, IRA data, and the like) and the recommendation based on predicted data of a financial state of the user 132.

At step 708c, the ICS controller 104 may transmit the user's 132 financial state and/or the recommendations to a third party. The third party may be an underwriter associated with a loan which was applied for by the user (or an entity associated with the user). For example, the underwriter may be tasked with underwriting (or evaluating a likelihood of success) associated with the loan applied for by the user/entity. The ICS controller 104 may be configured to transmit the user's financial state and/or recommendations to a device or portal associated with the underwriter. The underwriter may user the financial state and/or recommendations for approving/denying a loan application, or otherwise receiving more information relating to an applicant. While traditionally underwriters do not have ERP/CRM data available to them, the systems and methods described herein leverage such data to provide recommendations and predicted future financial states, which may be used for loan underwriting decisions.

### Section III: Systems and Methods for Generating a GUI for Reschedule of Payments

Enterprise resource planning (ERP) software may be complicated to use, poorly organized, and/or lack actionable user interfaces. Further, ERP software may not be have access to real-time financial data that is provided by a corresponding financial institution. As discussed further below, systems and method for generating a GUI are described. The systems and methods leverage data from ERP software, CRM software, and/or real time financial data to generate an interactive GUI that enables rescheduling payments while simultaneously providing financial data and suggested actions to a user of the GUI.

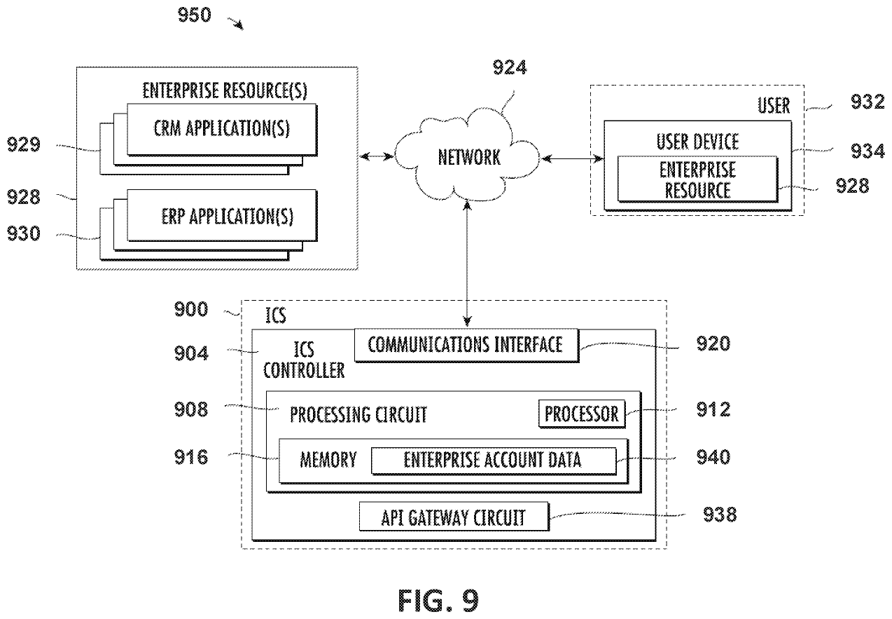

Referring now to FIG. 9, a schematic diagram of a computing system 950 is shown, according to an exemplary embodiment. The computing system 950 may share one or more characteristics as any of the other computing systems described herein. For example, the computing system 950 is shown to include an institution computing system (ICS) 900, which includes an ICS controller 904. The ICS controller 904 includes a processing circuit 908, having a processor 912 and a memory 916. The ICS controller 904 may also include, and the processing circuit 908 may be communicably coupled to, a communications interface 920 such that the processing circuit 908 may send and receive content and data via the communications interface 920. As such, the ICS controller 904 may be structured to communicate via one or more networks 924 with other devices and/or applications. The computing system 950 is shown to include enterprise resources 928 including a plurality of CRM applications 929 and a plurality of ERP applications 930, and a user device 934 accessing an enterprise resource 928 (which may be one of the enterprise resources 928). In some embodiments, the ICS controller 904, the enterprise resources 928, and the user device 934 may be communicably coupled and configured to exchange data over the network 924, which may include one or more of the Internet, cellular network, Wi-Fi, Wi-Max, a proprietary banking network, a proprietary retail or service provider network, or other type of wired or wireless network. The ICS controller 904 may be configured to transmit, receive, exchange, or otherwise provide data to one or more of the enterprise resources 928. The ICS controller 904 is shown to include an application programming interface (API) gateway circuit 938. The API gateway circuit 938 may be configured to facilitate the transmission, receipt, and/or exchange of data between the ICS controller 904 and the enterprise resources 928. Referring to FIG. 9 generally, the ICS controller 904 is associated with (e.g., owned, managed, and/or operated by) the institution computing system (ICS) 900. In the example depicted, the ICS 900 is a computing system configured to maintain data or content relating to one or more one or more enterprises (e.g., enterprise account data 940). According to the embodiments described herein, the ICS 900 may be configured to transmit existing enterprise account data 940 to one or more enterprise resources 928. For example, the ICS 900 may be configured to provide various content and data relating to different institution accounts, such as general ledger accounts, lending, money transfers, issuing credit or debit, etc. Thus, the ICS controller 904 is structured or configured to maintain and provide, or otherwise facilitate providing, the content and data (e.g., the enterprise account data 940) to devices and/or applications associated with internal or external users (e.g., users having an account with the institution corresponding to the ICS 900, users seeking to establish an account with the institution, etc.). In some embodiments, the ICS controller 904 is structured or configured control access to the enterprise account data 940 (e.g., by authenticating an enterprise resource 928 or a user of the enterprise resource 928).

In some embodiments, the ICS controller 904 may be implemented within a single computer (e.g., one server, one housing, etc.). In other embodiments, the ICS controller 904 may be distributed across multiple servers or computers, such as a group of two or more computing devices/servers, a distributed computing network, a cloud computing network, and/or any other type of computing system capable of accessing and communicating via local and/or global networks (e.g., the network 924). Further, while FIG. 9 shows applications outside of the ICS controller 904 (e.g., the network 924, the enterprise resources 928, etc.), in some embodiments, one or more of the enterprise resources 928 may be hosted within the ICS controller 904 (e.g., within the memory 916).

As shown in FIG. 9, the ICS controller 904 is shown to include the processing circuit 908, including the processor 912 and the memory 916. The processing circuit 908 may be structured or configured to execute or implement the instructions, commands, and/or control processes described herein with respect to the processor 912 and/or the memory 916. FIG. 9 shows a configuration that represents an arrangement where the processor 912 is embodied in a machine or computer readable media, as described below. However, FIG. 9 is not meant to be limiting as the present disclosure contemplates other embodiments, such as where the processor 912, or at least one circuit of processing circuit 908 (or ICS controller 104), is configured as a hardware unit. All such combinations and variations are intended to fall within the scope of the present disclosure.

The processing circuit 908 is shown to include the processor 912. The processor 912 may be implemented or performed with a general purpose single- or multi-chip processor, a digital signal processor (DSP), an application specific integrated circuit (ASIC), one or more field programmable gate array (FPGAs), or other suitable electronic processing components. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the circuits of the processor 912 may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit 908 is also shown to include the memory 916. The memory 916 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 916 may be or include tangible, non-transient volatile memory or non-volatile memory. The memory 916 may also include database components, object code components, script components, or any other type of information structure for supporting the activities and information structures described in the present application. According to an exemplary embodiment, the memory 916 is communicably connected to the processor 912 via the processing circuit 908 and includes computer code for executing (e.g., by the processing circuit 908 and/or the processor 912) one or more processes described herein.

The memory 916 is configured to store various data (e.g., some or all of the data required to perform the method 1400 described below). For example, the memory 916 may store previously recorded data (e.g., previous invoice payment dates, previous invoice payment amounts, historic account balances, etc.), current financial data (e.g., an account balance, outstanding invoices, accounts receivable, etc.), anticipated financial events (e.g., scheduled invoice payment dates, schedule payment request dates, etc.), and an optimized dataset within a single user interface for display to the user, as is discussed further below.

As shown in FIG. 9, the ICS controller 904 is also shown to include an application programming interface (API) gateway circuit 938. In some embodiments, the external devices (e.g., CRM application(s) 929 or ERP application(s) 930 of the enterprise resources 928, user device 934 having enterprise resource 928, etc.) may include API protocols that are used to establish an API session between the ICS controller 904 and the external devices. In this regard, the API protocols and/or sessions may allow the ICS 900 to communicate content and data (e.g., associated with the institution's products and/or services) to be displayed directly within the external devices (e.g., CRM application(s) 929, ERP application(s) 930, user device 934, etc.). For example, the external device may activate an API protocol (e.g., via an API call), which may be communicated to the ICS controller 904 via the network 924 and the communications interface 920. The API gateway circuit 938 may receive the API call from the ICS controller 904, and the API gateway circuit 938 may process and respond to the API call by providing API response data. The API response data may be communicated to the external device via the ICS controller 904, communications interface 920 and the network 924. The external device may then access (e.g., display) the API response data (e.g., associated with the ICS 900 product and/or service) on the external device.

As such, the API gateway circuit 938 is structured to initiate, receive, process, and/or respond to API calls (e.g., via the ICS controller 904 and the communications interface 920) over the network 924. That is, the API gateway circuit 938 may be configured to facilitate the communication and exchange of content and data between the external devices (e.g., CRM applications 929, ERP applications 930, user device 934, etc.) and the ICS controller 904. Accordingly, to process various API calls, the API gateway circuit 938 may receive, process, and respond to API calls using other circuits, as discussed below. Additionally, the API gateway circuit 938 may be structured to receive communications (e.g., API calls, API response data, etc.) from other circuits. That is, other circuits may communicate content and data to the ICS controller 904 via the API gateway circuit 938. Therefore, the API gateway circuit 938 is communicatively coupled other circuits of the ICS controller 904, either tangibly via hardware, or indirectly via software.

The ICS 900 is further shown to include a data ingestion engine 920. The data ingestion engine 920 is configured to receive or otherwise retrieve data, such as invoice data, associated with the entity from the enterprise resources 928 and/or from the ICS. The data may include datasets including data entries that define one or more characteristics of an invoice, such as an amount, due date, and one or more trade terms associated with payment of the invoice. For example, the data ingestion engine 920 may receive invoice data (e.g., invoice datasets) that is pulled via API calls from the ERP application 930 as described below.

The ICS 900 is further shown to include a machine learning (ML) engine 926. The ML engine 926 is configured to optimize an order for the datasets (e.g., invoice datasets) and output the optimized order for display within a user interface. For example, the ML engine 926 may receive a dataset including invoice data that is pulled via API calls from the ERP application. The ML engine 926 may then begin with an initial order of the dataset. For example, the order of the data entries of the dataset may be randomized. Alternatively, the data entries may be ordered by the due date associated with each invoice. The initial order of the dataset may be used as an input to the ML engine 926 along with other inputs such as financial data (e.g., predicted financial data, current account balance, etc.).

After initialization, the ML engine 926 evaluates the dataset. For example, the ML engine 926 may use the initial inputs to predict future financial data, such as a predicted account balance for a particular date based on the initial order of the dataset. The ML engine 926 may determine a score for the initial order of the dataset. According to various embodiments, an optimized dataset will have a higher score than a non-optimized dataset. For example, a higher score may indicate that the cash balance of the account remains positive and is relatively higher than the cash balances of datasets according to a different order. Further, the dataset may assign a score to each data entry according to the initial order. A data entry with a higher score may be more optimized than a data entry with a lower score.

After the initial evaluation, the ML engine 926 may select one or more data entries to fix and the order of other data entries may be adjusted. For example, data entries with higher scores may be fixed in order and data entries with lower scores may be adjusted. Some or all of the remaining entries may then be adjusted by the ML engine 926 and another iteration of steps may be described above may be performed until a maximized score is determined. The iteration with the maximum score may be the optimized order for the dataset.

According to various embodiments, the ML engine 926 may receive additional inputs that fix one or more of the data entries. For example, a user input may be received from the user device 934 that fixes one or more of the data entries. For example, as described further below, the user may interact with a user interface to adjust one or more of the data entries. In response, the ML engine 926 may fix the corresponding data entries and optimize the remainder of the data entries while fixing the one or more data entries fixed by the user.

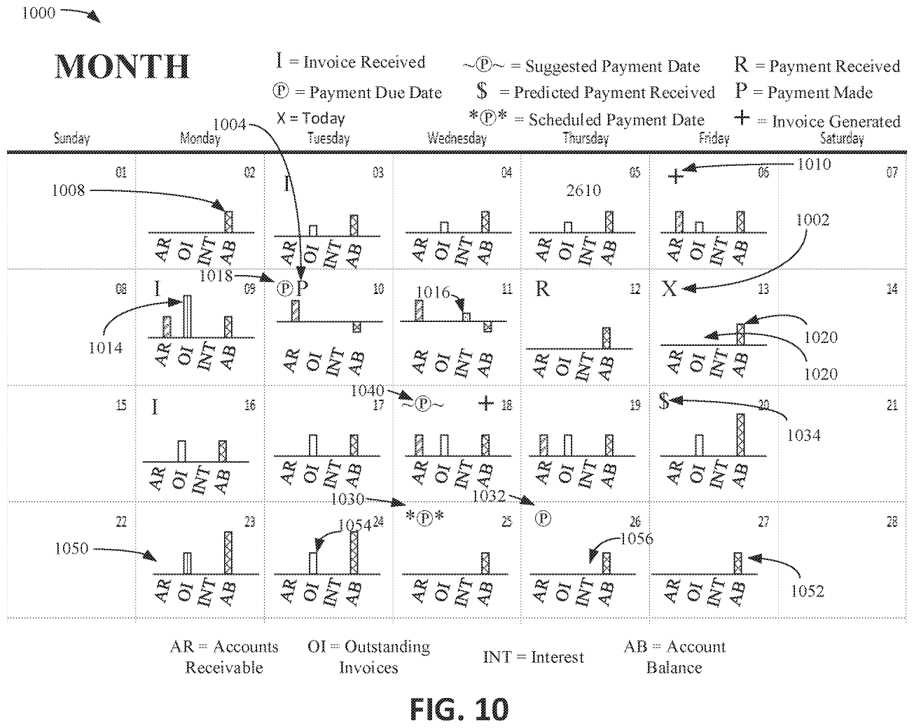

The ICS 900 is further shown to include a UI engine. The UI engine is configured to generate one or more user interfaces (UI) (e.g., the user interfaces shown in FIGS. 10-12). The UI engine 922 may receive data (e.g., invoice data) from the enterprise resource 928, the user device 924, and/or the ICS controller 904 and generate a corresponding user interface as is described further below. For example, the optimized dataset may be received by the UI engine 922 from the ML engine 926 and incorporated into the UI generated by the UI engine.

Still referring to FIG. 9, the computing system 950 may further include a plurality of enterprise resources 928. The enterprise resources 928 may be or include various systems or applications which are provided to an enterprise (e.g., by one or more service providers of the enterprise resource(s) 928). The enterprise resources 928 may be configured to facilitate management of resources corresponding to various entities in various industries. The enterprise resources 928 is shown to include a plurality of customer relationship management (CRM) applications 929. The CRM applications 929 may be or include applications for establishing leads on new customers, assisting in converting a lead to a sale, planning delivery, and so forth. The enterprise resources 928 is shown to include a plurality of ERP applications 930. The ERP applications 930 may include human resources (HR) or payroll applications, marketing applications, customer service applications, operations/project/supply chain management applications, commerce design applications, and the like.

The enterprise resources 928 is shown to further include invoice an invoice database 918. The invoice database 918 is configured to store invoices received by or otherwise accessed by the CRM applications 929, the ERP applications 930, or any other enterprise resource 928. The invoices may be generated by the enterprise (e.g., sent to a customer as a bill) and/or charged to the enterprise (e.g., sent to the enterprise as a bill). For example, the invoice database 918 may stores one or more invoice datasets for each invoice. According to various embodiments, each invoice dataset includes a plurality of data entries corresponding to respective invoices. Each data entry of the plurality of data entries may define an amount, due date, and one or more trade terms associated with payment of the invoice. According to various embodiments, the invoice data (e.g., invoice datasets) is pulled via API calls from the ERP application 930 as described below.

The enterprise resources 928 may be implemented on or otherwise hosted on a computing system, such as a discrete server, a group of two or more computing devices/servers, a distributed computing network, a cloud computing network, and/or another type of computing system capable of accessing and communicating using local and/or global networks (e.g., the network 924). Such computing system hosting the enterprise resources 928 may be maintained by a service provider corresponding to the enterprise resource(s) 928. The enterprise resources 928 may be accessible by various computing devices or user devices associated with an enterprise responsive to enrollment of the enterprise with the enterprise resources 928. The CRM applications 929 and/or the ERP applications 930 may include software and/or hardware capable of implementing a network-based or web-based applications (e.g., closed-source and/or open-source software like HTML, XML, WML, SGML, PHP, CGI, Dexterity, TypeScript, Node, etc.). Such software and/or hardware may be updated, revised, or otherwise maintained by resource or service providers of the enterprise resources 928. The CRM and ERP application(s) 929, 930 may be accessible by a representative(s) of a small or large business entity, any customer of the institution, and/or any registered (or unregistered) user of the products and/or service provided by one or more components of the computing system 950. As such, the enterprise resources 928 (including the CRM application(s) 929 and/or the ERP application(s) 930) may be or include a platform (or software suite) provided by one or more service providers which is accessible by an enterprise having an existing account with the ICS 900. In some instances, the enterprise resources 928 may be accessible by an enterprise that does not have an existing account with the ICS 900, but may open or otherwise establish an account with the ICS 900 using a CRM application 929 and/or an ERP application 930 of the enterprise resources 928, as described in greater detail below.

The enterprise resources 928 may be configured to establish connections with other systems in the computing system 950 (e.g., the ICS 900, the user device 934, etc.) via the network 924. Accordingly, the CRM application(s) 929 and/or ERP application(s) 930 of the enterprise resources 928 may be configured to transmit and/or receive content and data to and/or from the ICS controller 904 (e.g., via the communications interface 920) over the network 924. For example, and as described in greater detail below, an ERP application 930 (or CRM application 929) may activate an API protocol (e.g., via an API call) associated with the ICS 900 (e.g., to open an account, to request or apply for a loan instrument, to verify or determine an account balance, etc.). The API call may be communicated to the ICS controller 904 via the network 924 and the communications interface 920. The ICS controller 904 (e.g., the API gateway circuit 938) may receive, process, and respond to the API call by providing API response data. The API response data may be communicated to the ERP application 930 (or CRM application 929) via the communications interface 920 and the network 924, and the ERP application 930 (or CRM application 929) may access (e.g., analyze, display, review, etc.) the content and data received from the ICS 900.

In an exemplary embodiment, the enterprise resources 928 may be configured to include an interface that displays the content and data communicated from the ICS controller 904. For example, the enterprise resources 928 may include a graphical user interface, a mobile user interface, or any other suitable interface that may display the content and data (e.g., associated with products and services of the ICS 900) to the enterprise resources 928. In this regard, enterprise resources 928, and entities associated with the enterprise resources 928 (e.g., customers, employees, shareholders, policy holders, etc.), may access, view, analyze, etc. the content and data transmitted by the ICS controller 904 remotely using the enterprise resources 928.

Still referring to FIG. 9, the computing system 950 may further include a user device 934 associated e.g., owned by, used by, etc. with a user 932. The user device 934 may be or include a mobile phone, a tablet, a laptop, a desktop computer, an IoT-enabled device (e.g., an IoT-enabled smart car), a wearable device, a virtual/augmented reality (VR/AR) device, and/or other suitable user computing devices capable of accessing and communicating using local and/or global networks (e.g., the network 924). Wearable computing devices may refer to types of devices that an individual wears, including, but not limited to, a watch (e.g., a smart watch), glasses (e.g., eye glasses, sunglasses, smart glasses, etc.), bracelet (e.g., a smart bracelet), etc. In an exemplary embodiment, the user 932 may be a customer or client of the ICS 900 associated with the ICS controller 904 (e.g., a user having access to one or more accounts of another entity, such as a business or enterprise, another individual, etc.).

The user device 934 may be configured to establish connections with other systems in the computing system 950 (e.g., ICS 900, enterprise resources 928, etc.) via the network 924. Accordingly, the user device 934 may be able to transmit and/or receive content and data to and/or from the ICS controller 904 (e.g., via the communications interface 920) over the network 924. In some embodiments, the user device 934 may be able to transmit and/or receive content and data to and/or from the enterprise resources 928 over the network 924. In an exemplary embodiment, the user device 934 may include software and/or hardware capable of accessing a network-based or web-based application. For example, in some instances, the user device 934 may include an application that includes (closed-source and/or open-source) software such as HTML, XML, WML, SGML, PHP (Hypertext Preprocessor), CGI, Dexterity, TypeScript, Node, etc.

As shown in FIG. 9, the user device 934 is also shown to access an enterprise resource 928, which may be or include one or more of the enterprise resources 928 described herein (e.g., a CRM application 929, an ERP application 930). For example, a user of the enterprise resource 928 may provide log-in credentials associated with an enterprise, to access the corresponding enterprise resource 928. In some embodiments, the enterprise resource 928 may be a standalone application. In some embodiments, the enterprise resource 928 may be incorporated into one or more existing applications of the user device 934. The enterprise resource 928 may be downloaded by the user device 934 prior to its usage, hard coded in the user device 934, and/or be a network-based or web-based interface application. In this regard, the ICS controller 904 may provide content and data (e.g., relating to the ICS 900 products or services) to the enterprise resource 928 via the network 924, for displaying at the user device 934. The enterprise resource 928 may receive the content and data (e.g., directly from the ICS controller 904, or indirectly from the ICS controller 904), and the user device 934 may process and display the content and data remotely to the user through the enterprise resource 928 displayed at the user device 934.

The user device 934 is configured to interact with one or more user interfaces described below. For example, the user interfaces shown in FIGS. 10-12 may be provided to the user device 934 (e.g., from the ICS 900) for display. However, according to other embodiments, the user interfaces are generated by the user device 934. For example, the ICS 900 may provide some or all of the data required to generate a user interface and the user interface may be locally generated on the user device 934. The ICS 900 may pull the invoice data from the invoice database 918. For example, the ICS 900 may pull one or more invoice datasets from the invoice database 918 via an API call as is described further herein.

Further, the user device 934 may provide inputs to the ICS 900. For example, a user of the user device 934 may interact with a user interface on the user device 934, which may in turn send an update to the ICS 900. For example, the user may drag and drop a scheduled payment date within a user interface displayed on the user device 934, which may cause an update to be sent to the ICS 900 such that the ICS 900 updates the scheduled payment date accordingly.

In some embodiments, the user device 934 may prompt the user 932 to log onto or access a web-based interface before using the enterprise resource 928. Further, prior to use of the enterprise resource 928, and/or at various points throughout the use of the enterprise resource 928, the user device 934 may prompt the user 932 to provide various authentication information or log-in credentials (e.g., password, a personal identification number (PIN), a fingerprint scan, a retinal scan, a voice sample, a face scan, any other type of biometric security scan) to ensure that the user 932 associated with the user device 934 is authorized to use the enterprise resource 928 and/or permit the ICS to access the ERP data.

In an exemplary embodiment, an enterprise resource 928 accessed via the user device 934 may be configured to transmit, send, receive, communicate, or otherwise exchange data with the ICS 900. For example, an ERP application 930 (e.g., or CRM application 929) may have an option for viewing account information relating to accounts with the ICS 900. The user 932 of the user device 934 (e.g., a registered user having an account with the institution corresponding to the ICS 900) may select the option on the ERP application 930 to view the account information of the user 932 within the ERP application 930. The ERP application 930 may activate an API protocol (e.g., via an API call) to request the information from the ICS controller 904 corresponding to the account information. The ERP application 930 may communicate the API call to the ICS controller 904 via the network 924 and the communications interface 920. The ICS controller 904 (e.g., the API gateway circuit 938) may receive, process, and respond to the API call to provide API response data. For example, responsive to the ERP application 930 (or ICS controller 904) authenticating the user 932 as described herein, the ERP application 930 may transmit data corresponding to the user (e.g., a user identifier) with the API call to the ICS controller 904. The ICS controller 904 may perform a look-up function in an accounts database using the user identifier from the API call to generate the API response data including the enterprise account data 940. The API response data may be communicated to the ERP application 930 via the communications interface and the network 924. In some embodiments, the ERP application 930 may display the response data to the user 932 (e.g., via the ERP application(s) 930), such as the enterprise account data 940.

Similarly, the user device 934 may communicate with the ICS 900, via the network 924, requesting enterprise resource 928 data (e.g., data from a CRM application 929, data from an ERP application 930, etc.) to view on a page associated with the ICS 900. For example, the user device 934 may display a page or user interface corresponding to the ICS 900 that includes an option for viewing analytics on conversion of leads to sales from the CRM application 929. The user device 934 may receive a selection of the option, and initiate a request for the ICS 900 to request the customer information from the CRM application 929. The ICS 900 (e.g., the ICS controller 904 via the communications interface 920) may process the request from the user device 934 (e.g., as discussed herein), and activate an API protocol (e.g., via an API call) associated with the request (i.e., and the CRM application 929, etc.). The API call may be communicated to the CRM application 929 via the network. The CRM application 929 may receive, process, and respond to the API call by providing API response data as described herein. The API response data may be communicated to the ICS 900 (e.g., the ICS controller 904 via the network and the communications interface 920). In some embodiments, a webpage or website (or application) associated with the ICS 900 may display the CRM data received from the CRM application 929 along with ICS data (e.g., account data, balances, etc.).

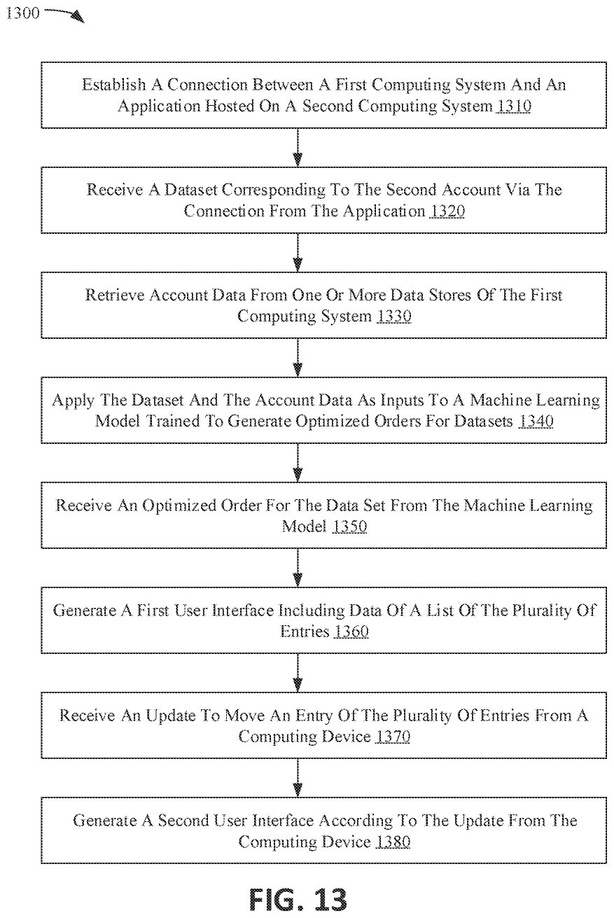

Referring now to FIG. 10, a user interface 1000 is shown, according to an example embodiment. The graphical user interface may be generated as a part of the method 1400, according to an example embodiment. For example, the user interface 1000 may be the first user interface generated as a part of step 1360 described below. As shown, the user interface 1000 displays the current date as indicated by the date marker 1002. The user interface 1000 further displays previously recorded data (e.g., previous invoice payment dates 1004, historic account balances 1008, historic invoice generation dates 1010, historic accounts receivable data 1012, historic open invoice totals 1014, historic interest payments made 1016, historic payment due dates 1018, etc.). According to various embodiments, the previously recorded data is received from the first computing system and/or the second computing system described below with respect to FIG. 13.

The user interface 1000 further includes current financial data (e.g., a current account balance 1020, current outstanding invoices 1022, current accounts receivable, current interest payments, etc.). For example, current financial data may be displayed in the calendar box that represents the present date (e.g., as indicated by the date marker 1002). According to various embodiments, the current financial data is received from the first computing system and/or the second computing system described below with respect to FIG. 13.

The user interface 1000 further includes anticipated financial events (e.g., scheduled invoice payment dates 1030, future invoice due dates 1032, schedule payment request dates 1034, etc.). The anticipated financial events may be determined based on data (e.g., invoice data, enterprise data, etc.) received from the first computing system and/or the second computing system described below with respect to FIG. 13. For example, the future invoice due date 1032 may be determined based on invoice data received. In an example embodiment, an digital invoice is uploaded to at least one of the CRM application 929 or the ERP application 930. An optical character recognition (OCR) process may be performed to determine and extract invoice data based on character matching from the invoice data and/or data formats of the characters (e.g., mm-dd-yyyy for invoice due dates). Alternatively, an API call to the invoice database 918 may retrieve invoice data including invoice identifier, invoice amounts, and due dates.

The user interface 1000 further includes predicted financial information (e.g., a predicted accounts receivable 1050, predicted outstanding invoices 1054, predicted interest payment 1056, predicted account balances 1052, etc.). The predicted financial information may be determine by one or more of the machine learning models described herein. According to various embodiments, some or all of the predicted financial information may be determined by the ML engine 926, as described above with respect to FIG. 9.

According to various embodiments, the user interface includes two sets of predicted financial information. The first set of predicted financial information may display predicted financial information based on the current order of the dataset (e.g., using scheduled payment dates). The second set of predicted financial information may display predicted financial information based on the optimized order of the dataset as determined by the machine learning model (e.g., using suggested payment dates).

The user interface 1000 further includes the optimized dataset (e.g., a suggested payment date 1040). For example, the machine learning model (e.g., the ML engine 926) may optimize the dataset be reordering payment dates to maximize the entities account balance. According to various embodiments, the optimized dataset includes a plurality of suggested payment dates. For example, the ML engine 926 may determine an optimized order for the dataset as described above with respect to FIG. 9.

As discussed herein, the user interface 1000 may include visual indicators that indicate the relative account balance of the entity. For example, the visual indicators may include a heat map that color codes one or more of the dates of the calendar based on the relative account balance. For example, on the day with the highest historical or predicted account balance, the box representing the corresponding date on the calendar may be a relatively dark shade of green. On the days with the lowest negative historical or predicted account balance, the box representing the corresponding date on the calendar may be a relatively dark shade of red. In an example embodiment, the days with a positive account balance (e.g., historic and/or predicted) the box that represents the corresponding date may be green, with the highest account balances being a deeper shade of green and the lower, but still positive, account balances being a lighter shade of green. Further, the days with a negative account balance (e.g., historic and/or predicted) the box that represents the corresponding date may be red, with the lowest account balances being a deeper shade of red and the higher, but still negative, account balances being a lighter shade of red.

As discussed further herein, the user interface 1000 may be configured for display on a computing device (e.g., the user device 134). Further, the user interface 1000 may be interacted with on the computing device such that a user of the computing device may provide an input to update one or more of the entries displayed within the user interface. After a user input is received, the user interface 1000 may be updated as is discussed below.

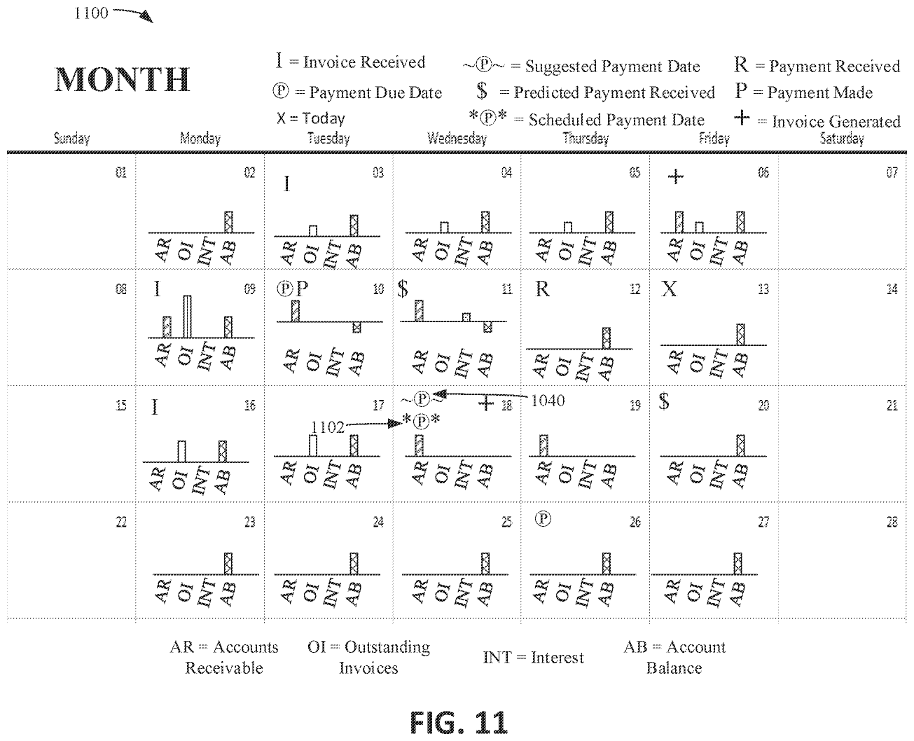

Referring now to FIG. 11, another user interface 1100 is shown, according to an example embodiment. The user interface 1100 may be generated as a part of the method 1300 (e.g., at step 1380). For example, the user interface 1100 may a second user interface generated in response to receiving an update from the computing device. For example, the user interface 1100 may be generated in response to the scheduled payment date 1030 being moved. As shown, the scheduled payment date 1030 was moved from the 25th to the 18th of the month, which is the same date as the suggested payment date 1040 determined by the machine learning model (the ML engine 926). For example, the user may drag and drop the scheduled payment date 1030 to a desired date, which may cause the payment to be rescheduled.

According to various embodiments, an alert is displayed within the user interface 1100 if the user updates one or more entries and the machine learning model (e.g., the ML engine 926) predicts a critical condition in response to the user update. For example, if the user adjust a scheduled payment date that results in the predicted account balance falling below a predetermined threshold (e.g., below $0), an alert may be displayed within the user interface 1100. The alert may suggest reverting to previously scheduled payment date and include an input option that allows the user to revert to the previous payment schedule.

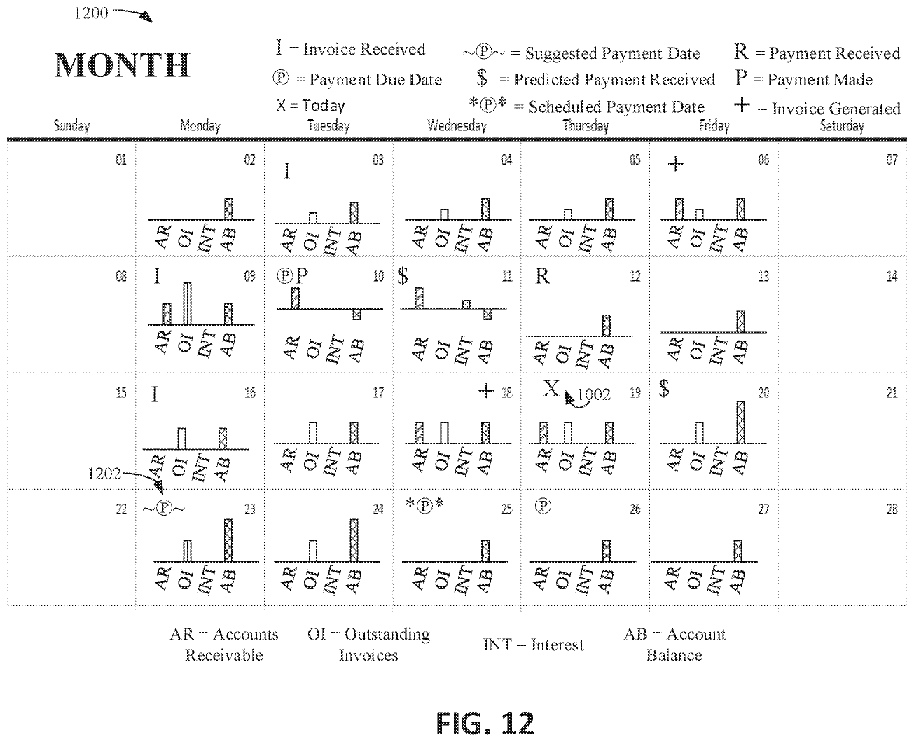

Referring now to FIG. 12, another user interface 1200 is shown according to an example embodiment. The user interface 1200 may be generated as a part of the method 1400 described below. For example, the user interface 1200 may be generated in response to applying the dataset and the account data at a second time instance (e.g., at a later time than the user interface 1000 described above). For example, as indicated by the date marker 1002, the graphical user interface is generated several days after the first user interface 1000 shown in FIG. 11. As shown, a new suggested payment date 1202 is determined based on the current date and any updated data that was received since the previous user interface was generated. For example, the updated data may be provided to the machine learning model (e.g., the ML engine 926) to determine the new suggested payment date 1202.

Referring now to FIG. 13, a flowchart of a method 1300 for optimizing orders for datasets and generating a corresponding graphical user interface is shown, according to an example embodiment. The method 1300 is configured to receive or retrieve transaction data (e.g., supplier trade terms, invoice data, trade terms, invoice discount data, invoice discount amount, invoice amount from another party, etc.), account data (e.g., various balances, expected or scheduled payments or transfers into or out of an account, etc.), and other datasets, provide the received or retrieved data to a machine learning module (e.g., the ML engine 926) trained to generate optimized orders for datasets based on the data, generate a graphical user interface (GUI) to display the optimized orders for datasets, receive user input(s) within the graphical user interface, and adjust the GUI based on the user input(s).

The method 1300 may be performed by leveraging data generated by a Customer Relationship Management (CRM) application being utilized by a user (e.g., a customer), an Enterprise Resource Planning (ERP) application utilized by the user, and/or financial institution data generated by a financial institution supporting the user, to automatically determine an optimized order for a dataset, which may include scheduled payment dates, payment amounts, etc. Accordingly, training the machine learning model (e.g., the ML engine 926) using historic enterprise resource data holistically, the machine learning model may predict the future financial state of the user based on historic data/factors of the enterprise, resulting in improved future predictions (e.g., forecasting) over predictions that are determined individually and/or independently. The method may be performed by one or more components of the systems described herein. It should be appreciated that the method 1300 does not need to be performed in the order shown. Further, various steps may be omitted and additional steps may be included in the method 1300.

At step 1310, a connection is established between a first computing system and an application hosted on a second computing system. According to various embodiments, the connection is associated with an entity (e.g., a business, an individual, etc.) having one or more first accounts with the first computing system (e.g., a financial computing system) and a second account with the application of the second computing system (e.g., an enterprise computing system). The first account may be a financial account (e.g., savings account, credit account, checking account, etc.) with a financial institution. The second account may be associated with an any of the applications discussed herein (e.g., a CRM application, an ERP application, etc.). For example, an ICS controller may be configured to establish a connection between the ERP application and institution application corresponding to the ICS, as is discussed further herein.

In an example embodiment, the first account (e.g., associated with the first server) and the second account (e.g., associated with the second server) are linked to a common account holder (e.g., a user, entity, etc. having, applying, utilizing, etc. one or more accounts via the first application and the second application). The first account and/or the second account may be associated with any of the applications discussed herein. For example, the first account and/or second account may be associated with an institution application (e.g., of the ICS 100), the CRM application 129 (e.g., applications for establishing leads on new customers, assisting in converting a lead to a sale, planning delivery, and so forth), the ERP application 130 (e.g., HR or payroll applications, marketing applications, customer service applications, operations/project/supply chain management applications, commerce design applications, and the like), and/or any other suitable application. According to an exemplary embodiment, the first account is associated with a financial institution application (e.g., of the ICS 100, etc.), and the second account is associated with at least one of the ERP application 130 or the CRM application 129. As discussed herein, the first account and/or the second account may be implemented on, or otherwise hosted on, any suitable computing system or device (e.g., the ICS 100, the user device 134, a discrete server, a group of two or more computing devices/servers, a distributed computing network, a cloud computing network, and/or another type of computing system capable of accessing and communicating using local and/or global network, etc.).

At step 1320, a dataset corresponding with the second account is received via the connection from the application. The dataset may include a plurality of data entries corresponding to respective invoices, each data entry of the plurality of data entries comprising an amount, due date, and one or more trade terms associated with payment of the invoice. For example, the dataset may include invoice data including a recipient identifier, a recipient name, an invoice number, an invoice amount, and so forth, and invoice due date, invoice late fees, etc. At least a portion of the data set may be received from the first application associated with the first computing system. The first application retrieves at least a portion of data associated with the common account holder, according to an exemplary embodiment. In an exemplary embodiment, the portion of data is accessible via the second application associated with the second computing system. More specifically, the first application (e.g., the ERP application 130, the CRM application 129, etc.) may receive the one or more API calls, and/or the additional data, via an API gateway circuit. The API gateway circuit may be configured to receive the one or more API calls, identify at least one of a plurality of circuits that is best configured to process the API call, and/or route the one or more API calls to the identified API circuit or circuits. The identified circuit (or circuits) may receive and/or process the API call, and provide output data (e.g., API response data) associated with the API call and/or the associated account holder. For example, the output data (e.g., API response data) may include account balance or transaction information for planning delivery payroll information, marketing information, customer service information, operations/project/supply chain management information, commerce design information, and/or any other suitable information associated with the first application (e.g., enterprise name, management information, principle place of business, tax information, etc.). In some embodiments, the output data (e.g., API response data) includes a portion of the additional data received from the second application, and/or data associated with the second application stored at the first application (e.g., account aggregation information, account balance information, transaction detail information, account information, validation information, lending or loan information, foreign exchange information, payment initiation information, payment initiation requests, confirmation of funds information, and/or any other suitable information associated with the second application, etc.).

At step 1330, account data is received from one or more data stores of the first computing system. The account data may correspond with the one or more first accounts with the first computing system. For example, the first computing system may include one or more processors configured to generate and store various enterprise resource data including accounts receivable data, accounts payable data, account balance data, liquid asset data, illiquid asset data, customer recommendations, underwriter replies, customer replies etc. and the various outputs may include future accounts receivable data, future accounts payable data, future account balance data, future liquid asset data, future illiquid asset data, training customer recommendations, training underwriter replies, training customer replies etc. According to various embodiments, the enterprise resource dataset is stored in a data repository. For example, the data repository may be accessible by one or more machine learning models (e.g., the ML engine 926) as is discussed further herein. According to various embodiments, the ICS controller may receive the enterprise resources data, including data from CRM applications, data from ERP applications, and/or data from a financial institution computing system.

At step 1340, the dataset and the and the account data are applies as inputs to a machine learning model (e.g., the ML engine 926) trained to generate optimized orders for datasets. For example, the dataset and the account data received/retrieved at processes 1320 and 230 may be used as inputs to a machine learning model trained to generate optimized orders for datasets based on data of data entries of the dataset and corresponding account data. The process 1340 may involve providing the dataset to one or more of the machine learning models discussed herein (e.g., the machine learning model 504, the machine learning engine 926, etc.). For example, the ICS controller may provide the inputs to the machine learning model to generate optimized orders for datasets based on the data of data entries of the dataset and corresponding account data.

For example, a first machine learning model (e.g., the ML engine 926) may be trained to optimize an order of a dataset that includes invoice payment dates, payment requested dates, etc. using a plurality of training financial inputs and a plurality of training financial outputs, as described above with respect to FIG. 9. Optimizing the dataset may include determining one or more dates to make invoice payments, the corresponding amount of the invoice payment to be made, payment collection dates, and the corresponding payment amount requested to be made on the payment date to achieve one or more of the user's goals (e.g., maximize profit, maintain a positive cash flow, minimize interest payments, etc.). According to various embodiments, each of the plurality of training financial inputs corresponds with financial data captured on or before a first date and each of the plurality of training financial outputs corresponding with financial data captured on or after a second date subsequent to the first date. In other words, the machine learning model is trained to predict future financial outputs (e.g., invoice payment dates, payment request dates, etc.) based on historic financial input data that is being generated by a Customer Relationship Management (CRM) application being utilized by a user (e.g., a customer), an Enterprise Resource Planning (ERP) application being utilized by the user, and/or financial institution data generated by a financial institution supporting the user.

The machine learning model (e.g., the ML engine 926, the machine learning model 504, etc.) may predict one or more optimal invoice payment dates based on current user (e.g., the customer) enterprise resources data, including data from CRM applications, data from ERP applications, and/or data from a financial institution computing system. The optimal invoice payment date may be a date the machine learning model determines the user should make a payment on an invoice to achieve one or more of the user's goals. For example, the machine learning model may be trained to maintain a positive cash flow for the user. To achieve this goal, the machine learning model may determine the optimal invoice payment date is after an invoice due date. For example, the user may not have sufficient funds to pay an invoice before the due date of the invoice. The machine learning model may determine an optimal invoice payment date that is after the invoice due date, which may result in interest on the invoice being incurred by the user, and after an expected payment requested date (e.g., a date the user has requested a customer to remit payment for an invoice the user generated), to maintain positive cash flow.

The machine learning model (e.g., the ML engine 926, the machine learning model 504, etc.) may predict one or more optimal invoice payment amounts based on current user (e.g., the customer) enterprise resources data, including data from CRM applications, data from ERP applications, and/or data from a financial institution computing system. The optimal invoice payment amount may be a portion the amount owed in an invoice. For example, the machine learning model may determine a first optimal invoice payment amount to be paid on a first optimal invoice payment date and a second optimal invoice payment amount to be paid on a second optimal invoice payment date for a single invoice based on the user's goals. For example, the machine learning model may be trained to maximize profit. To achieve this goal, the machine learning model may determine whether a dollar amount redeemable in response to paying some or all of an invoice early is worth paying the invoice early (e.g., whether the discount is advantageous to the enterprise). The machine learning model may determine whether the dollar amount redeemable is worth paying the invoice early by calculating, for instance, the annualized interest from the trade discount. If the annualized interest rate is higher than the cost of borrowing money to pay the invoice early, then the machine learning model may determine that the dollar amount redeemable from the vendor is worth paying the invoice early.

The machine learning model may use the training inputs (e.g., accounts receivable data, accounts payable data, account balance data, liquid asset data, illiquid asset data, 401k data, IRA data, and the like) to predict outputs (e.g., future accounts receivable data, future accounts payable data, future account balance data, future liquid asset data, future illiquid asset data, future 401k data, future IRA data, and the like), by applying the current state of the machine learning model to the training inputs. In some embodiments, the machine learning circuit may include one or more machine learning models trained to predict a future enterprise account balance. In these embodiments, the machine learning models of the machine learning circuit may ingest financial data (e.g., accounts receivable, accounts payable, account balance, liquid assets, assets, etc.) and analyze the ingested data using trained machine learning model(s) to predict future financial data.

The machine learning model may also access one or more databases using API gateway circuit. In some embodiments, the data received from databases may include trained machine learning models, thresholds, and the like, as is discussed further herein. Alternatively or additionally, an enterprise may store trained machine learning models and/or threshold. Alternatively or additionally, the SFE 406 may store the trained machine learning models and/or thresholds. As such, the SFE 406 may include, maintain, or otherwise access the trained machine learning models described herein.

It should be appreciated that the machine learning model may perform any of all of the steps of any of the methods described herein. For example, the machine learning model may determine the financial health of the entity, determine financing options, determine one or more recommendations, etc.

At step 1350, the optimized order for the dataset is received from the machine learning model. For example, a list of optimized invoice payment dates, invoice payment amounts, payment request dates, payment request amounts, etc. may be received from the machine learning model. The dataset may include a corresponding date for each data entry of the dataset (e.g., a predicted optimal invoice payment date, a predicted optimized payment request date, etc.). Further, at process 1350 a plurality of optimized orders for the dataset may be received from the machine learning model.

At step 1360, a first user interface, including data of a list of the plurality of entries, is generated. The user interface may include the plurality of entries being ordered according to the optimized order for the dataset, as determined by the machine learning model. According to various embodiments, the user interface may include a calendar used to display the optimized order. For example, the user interface may include a calendar that displays the optimized dataset by showing the invoice payment dates (e.g., the payment dates suggested by the machine learning model).

The user interface may also include other data available to the ICS controller such as enterprise resources data, including data from CRM applications, data from ERP applications, and/or data from a financial institution computing system. In this sense, the user interface may simultaneously include previously recorded data (e.g., previous invoice payment dates, previous invoice payment amounts, historic account balances, etc.), current financial data (e.g., an account balance, outstanding invoices, accounts receivable, etc.), anticipated financial events (e.g., scheduled invoice payment dates, schedule payment request dates, etc.), and the optimized dataset within a single user interface for display to the user. Further, the user may interact with the user interface to adjust one or more data point included in the user interface.

As is discussed further above, the user interface may include one or more visual indicators corresponding with the historical and/or predicted financial health of the entity. For example, the visual indicators may indicate the relative account balance of the entity. For example, the visual indicators may include a heat map that color codes one or more of the dates of the calendar based on the relative account balance. For example, on the day with the highest historical or predicted account balance, the box representing the corresponding date on the calendar may be a relatively dark shade of green. On the days with the lowest negative historical or predicted account balance, the box representing the corresponding date on the calendar may be a relatively dark shade of red. In an example embodiment, the days with a positive account balance (e.g., historic and/or predicted) the box that represents the corresponding date may be green, with the highest account balances being a deeper shade of green and the lower, but still positive, account balances being a lighter shade of green. Further, the days with a negative account balance (e.g., historic and/or predicted) the box that represents the corresponding date may be red, with the lowest account balances being a deeper shade of red and the higher, but still negative, account balances being a lighter shade of red.

At step 1370, an update to move an entry of the plurality of entries is received from the computing device. For example, a user may use a computer device to interact with the user interface to update at least one of the plurality of entries. For example, the user may drag and drop one of the entries to a new date within the calendar. For example, the user interface may display a suggested payment date (e.g., an invoice payment date suggested by the machine learning model) and the user may drag and drop the corresponding scheduled payment date to a new date (e.g., the suggested payment date) to reschedule the payment date.

According to various embodiments, the update to move an entry includes a selection of a subset of a plurality of dates in which to move the entry. For example, the update may include changing a scheduled invoice payment date to a plurality of different dates. In response to this update, a second user interface may be generated that includes data (e.g., predicted account balances) for each scenario corresponding to the subset of the plurality of dates.

At step 1380, a second user interface is generated according to the update from the computing device. For example, the user may drag and drop a scheduled invoice payment date at process 1370 and a second user interface may be generated that shows the updated scheduled invoice payment date. According to various embodiments, after step 1370, the updated plurality of entries is provided to the machine learning model and the machine learning model will optimize the plurality of entries based on the updated entry. According to various embodiments, the user input may include a request to lock the position of the entry (e.g., lock an invoice payment date). In this example embodiment, the machine learning model will determine an optimized order of the remainder of the plurality of entries according to the locked position of the entry.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quadcore processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed:

1. A method comprising:
establishing, by one or more processors of a first computing system, a connection between the first computing system and an application hosted on one or more servers of a second computing system, the connection associated with an entity having one or more first accounts with the first computing system and a second account with the application of the second computing system;
receiving, by the one or more processors, via the connection from the application, a dataset corresponding to the second account, the dataset comprising a plurality of data entries corresponding to respective invoices, each data entry of the plurality of data entries comprising an amount, due date, and one or more trade terms associated with payment of the invoice;
retrieving, by the one or more processors, from one or more data stores of the first computing system, account data corresponding to the one or more first accounts with the first computing system;
applying, by the one or more processors, the dataset and the account data as inputs to a machine learning model trained to generate optimized orders for datasets based on data of data entries of the dataset and corresponding account data;
receiving, by the one or more processors, from the machine learning model, an optimized order for the dataset;
generating, by the one or more processors, a first user interface including data of a list of the plurality of entries, the plurality of entries being ordered according to the optimized order for the dataset;
receiving, by the one or more processors, from a computing device, an update to move an entry of the plurality of entries; and
generating, by the one or more processors, a second user interface according to the update from the computing device.

2. The method of claim 1, further comprising:
applying, by the one or more processors, at a second time instance, the dataset, the account data, and a locked position of the entry according to the update, to the machine learning model; and
receiving, by the one or more processors, a second optimized order for the dataset according to the locked position of the entry.

3. The method of claim 2, wherein the second user interface includes the data of the list of the plurality of entries ordered according to the second optimized order for the dataset.

4. The method of claim 1, further comprising:
receiving, by the one or more processors, a user entry corresponding to an expected change to the account data at a future date,
wherein the user entry is applied to the machine learning model as another input for generating the optimized order.

5. The method of claim 1, wherein the first user interface comprises a calendar view for a time window, wherein each entry of the plurality of entries is represented as a respective element on a date box of the calendar view.

6. The method of claim 5, wherein the calendar view comprises a heat map showing a value corresponding to the account data changing over the time window.

7. The method of claim 5, wherein receiving the update comprises receiving, by the one or more processors, a drag-and-drop of an element corresponding to the entry from a first date box to a second date box of the calendar view.

8. The method of claim 7, wherein the second user interface comprises an update to a heat map of the first user interface based on the element being moved from the first date box to the second date box.

9. The method of claim 1, wherein the update comprises a selection of a subset of a plurality of dates in which to move the entry, and wherein the second user interface includes data corresponding to account balances for each scenario corresponding to the subset of the plurality of dates.

10. The method of claim 1, wherein the second user interface comprises an alert displayed over the first user interface, the alert indicating that the update is estimated to cause a negative balance.

11. A first computing system comprising:
one or more processors configured to:
establish a connection between the first computing system and an application hosted on one or more servers of a second computing system, the connection associated with an entity having one or more first accounts with the first computing system and a second account with the application of the second computing system;
receive, via the connection from the application, a dataset corresponding to the second account, the dataset comprising a plurality of data entries corresponding to respective invoices, each data entry of the plurality of data entries comprising an amount, due date, and one or more trade terms associated with payment of the invoice;
retrieve, from one or more data stores of the first computing system, account data corresponding to the one or more first accounts with the first computing system;
apply the dataset and the account data as inputs to a machine learning model trained to generate optimized orders for datasets based on data of data entries of the dataset and corresponding account data;
receive, from the machine learning model, an optimized order for the dataset;
generate a first user interface including data of a list of the plurality of entries, the plurality of entries being ordered according to the optimized order for the dataset;
receive, from a computing device, an update to move an entry of the plurality of entries; and
generate a second user interface according to the update from the computing device.

12. The first computing system of claim 11, wherein the one or more processors are configured to:
apply, at a second time instance, the dataset, the account data, and a locked position of the entry according to the update, to the machine learning model; and
receive a second optimized order for the dataset according to the locked position of the entry.

13. The first computing system of claim 12, wherein the second user interface includes the data of the list of the plurality of entries ordered according to the second optimized order for the dataset.

14. The first computing system of claim 11, wherein the one or more processors are configured to:
receive a user entry corresponding to an expected change to the account data at a future date,
wherein the user entry is applied to the machine learning model as another input for generating the optimized order.

15. The first computing system of claim 11, wherein the first user interface comprises a calendar view for a time window, wherein each entry of the plurality of entries is represented as a respective element on a date box of the calendar view.

16. The first computing system of claim 15, wherein the calendar view comprises a heat map showing a value corresponding to the account data changing over the time window.

17. The first computing system of claim 15, wherein receiving the update comprises receiving, by the one or more processors, a drag-and-drop of an element corresponding to the entry from a first date box to a second date box of the calendar view.

18. The first computing system of claim 17, wherein the second user interface comprises an update to a heat map of the first user interface based on the element being moved from the first date box to the second date box.

19. The first computing system of claim 11, wherein the update comprises a selection of a subset of a plurality of dates in which to move the entry, and wherein the second user interface includes data corresponding to account balances for each scenario corresponding to the subset of the plurality of dates.

20. A non-transitory computer readable medium storing instructions that, when executed by one or more processors of a first computing system, cause the one or more processors to:
establish a connection between the first computing system and an application hosted on one or more servers of a second computing system, the connection associated with an entity having one or more first accounts with the first computing system and a second account with the application of the second computing system;
receive, via the connection from the application, a dataset corresponding to the second account, the dataset comprising a plurality of data entries corresponding to respective invoices, each data entry of the plurality of data entries comprising an amount, due date, and one or more trade terms associated with payment of the invoice;
retrieve, from one or more data stores of the first computing system, account data corresponding to the one or more first accounts with the first computing system;
apply the dataset and the account data as inputs to a machine learning model trained to generate optimized orders for datasets based on data of data entries of the dataset and corresponding account data;
receive, from the machine learning model, an optimized order for the dataset;
generate a first user interface including data of a list of the plurality of entries, the plurality of entries being ordered according to the optimized order for the dataset;
receive, from a computing device, an update to move an entry of the plurality of entries; and
generate a second user interface according to the update from the computing device.
